(19) United States
(12) Patent Application Publication
(10) Pub. No.: US 2024/0089296 A1
(43) Pub. Date: Mar. 14, 2024

(54) COMPUTER IMPLEMENTED SYSTEMS AND METHODS FOR PROVIDING A MULTIPURPOSE CONTROL AND NETWORKING PLATFORM

(71) Applicant: NEP Supershooters, L.P., Pittsburgh, PA (US)

(72) Inventors: Daniel Royce Murphy, Surry Hills (AU); Neil George Smith, Brisbane (AU); John Guntenaar, Putten (NE); Koen Hendrikus Franciscus Rutgerus Van Haaren, Amsterdam (NE); Leander Serrao, Point Cook (AU); Christopher Swinerton, Abbotsford (AU)

(73) Assignee: NEP Supershooters, L.P., Pittsburgh, PA (US)

(21) Appl. No.: 18/464,730

(22) Filed: Sep. 11, 2023

Related U.S. Application Data
(60) Provisional application No. 63/375,219, filed on Sep. 9, 2022.
(60) Provisional application No. 63/490,992, filed on Mar. 17, 2023.
(60) Provisional application No. 63/496,388, filed on Apr. 15, 2023.

(51) Int. Cl. H04L 9/40; H04L 67/1008

(52) U.S. Cl. CPC H04L 63/20; H04L 63/107; H04L 63/123; H04L 67/1008

(57) ABSTRACT

In accordance with one implementation, computer-implemented systems and methods are provided for multipurpose control and networking. Some disclosed embodiments involve systems, methods, and computer readable media for dynamically connecting devices for secure communications. Some disclosed embodiments involve systems, methods, and computer readable media for configuring and providing software-defined networking solutions.

### CROSS-REFERENCE TO RELATED APPLICATION(S)

This application claims priority to U.S. Provisional Application No. 63/375,219, filed Sep. 9, 2022, U.S. Provisional Application No. 63/490,992, filed Mar. 17, 2023, and U.S. Provisional Application No. 63/496,388, filed Apr. 15, 2023. Each of the above-referenced applications is expressly incorporated herein by reference in its entirety.

### TECHNICAL FIELD

The present disclosure generally relates to the field of computing systems and data processing systems and methods. More specifically, and without limitation, this disclosure relates to computer-implemented systems and methods for a multipurpose control and networking platform. The present disclosure also relates to systems and methods for dynamically connecting devices for secure communications and configuring and managing service solutions and/or features. These and other aspects are encompassed by the present disclosure.

### BACKGROUND

System integration and production is the process of linking together different computing systems and software applications to provide one or more production services, including for the recording and broadcasting of live events. This process generally involves integrating existing, disparate equipment, software applications, and systems. Such systems and software applications may be implemented for various purposes and solutions, such as digital media and entertainment services designed to deliver content on a global scale. In extant systems and environments, digital asset management, video creation and distribution, virtual production, broadcasting, and streaming, amongst other creative endeavors, continue to evolve and require adaption to ongoing trends and technology disruptions.

There are numerous technical challenges and needs that exist with such extant systems, in addition to managing the above-mentioned equipment and variables. For example, system integration and collaboration may be challenging to implement across multiple venues or different production locations and/or where different devices and technology must be used. Other challenges exist in terms of managing resources and communicating large volumes of data, the inability to securely communicate and share data, and difficulties outsourcing operations to third parties. This can give rise to high integration and operations costs, production delays, and inefficient uses of resources.

Still further, extant systems and methods fail to provide effective and efficient solutions for managing and connecting disparate systems and software applications. There is also a need for improved methods for providing user access and authenticating users and/or devices. In addition, improvements are needed to provide flexibility to users and/or devices to access and connect with independent systems and software applications in a technologically agnostic manner. These and other drawbacks and technological needs are addressed by embodiments of the present disclosure.

### SUMMARY

The present disclosure generally relates to the field of computing systems and data processing systems and methods. Moreover, and without limitation, this disclosure relates to computer-implemented systems and methods for a multipurpose control and networking platform.

Embodiments of the present disclosure provide improved solutions for system integration and management of applications and resources. Among other things, the disclosed embodiments provide solutions for efficiently bringing together systems, software applications, facilities, networks, and cloud-based services using a unified, feature-rich platform. Advantageously, the embodiments disclosed herein can bring together and connect multiple, disparate systems to the unified, feature-rich platform and provide highly complex setups and production methods seamless and in a simplified and efficient manner. Systems and methods consistent with the embodiments of this disclosure can also provide rapid technology-agnostic deployments, configurations, and monitoring for software-defined networking solutions.

Embodiments of the present disclosure include computer-implemented systems and methods for a multipurpose control and networking platform. Systems consistent with some embodiments may include a plurality of networked devices comprising broadcasting devices. The broadcasting devices may transmit at least one of audio signals, video signals, or data signals. The plurality of networked devices may be dynamically connected for secure communications with at least one processor (e.g., a server or computing platform). The at least one processor may be configured to configure at least one of a service solution or a feature. The at least one processor may also be configured to deploy, among the plurality of networked devices, at least one of the service solution or the feature using one or more standalone local clusters for the plurality of networked devices. The at least one processor may also be configured to monitor and control the deployment of the at least one of the service solution or the feature.

Embodiments of the present disclosure also include computer-implemented systems and methods for dynamically connecting devices for secure communications. In some embodiments, a system is provided that includes at least one primary node communicatively connected to at least one secondary node. In some embodiments, the at least one primary node may be configured for connecting the plurality of networked devices to a broadcast controller. The broadcast controller may be configured to control and transmit at least one of audio signals, video signals, or data signals captured by the plurality of networked devices to multiple recipient devices. In some embodiments, the at least one secondary node may be configured for connecting at least a first device of the plurality of networked devices to the at least one primary node. The system may also include at least one processor. The at least one processor may be configured to connect, using the at least one primary node and/or the at least one secondary node, at least the first device for secure communications with the broadcast controller. The at least one processor may also be configured to manage the secure communications with the broadcast controller.

Still further, embodiments of the present disclosure include computer-implemented systems and methods for providing a software-defined network for broadcasting. In some embodiments, a system is provided that includes a plurality of devices. The system may also include a broadcast controller configured to control and transmit at least one of audio signals, video signals, or data signals from the plurality of devices to multiple recipient devices. The system may also include at least one processor. The at least one processor may be configured to connect, via a new connection, at least one of the plurality of devices to the broadcast controller. The at least one processor may also be configured to scan the new connection to detect a newly connected device or a user of the connected device. The at least one processor may further be configured to dynamically adapt at least one of a service solution or a feature in response to the detected newly connected device or user thereof.

Consistent with the present disclosure, computer-implemented systems are provided that include one or more computing apparatuses configured to perform particular operations or actions by virtue of having software, firmware, hardware, or a combination of them installed thereon that in operation causes or cause the computing apparatus to perform the operations or actions. For example, one or more computer programs may be configured to perform operations or actions by virtue of including instructions that, when executed by a data processing apparatus (such as one or more processors), cause the apparatus to perform such operations or actions.

The foregoing and following examples are provided for the convenience of the reader to provide a basic understanding of such embodiments and does not wholly define the breadth of the present disclosure. Therefore, the above summary is not an extensive overview of all contemplated embodiments and is intended to neither identify key or critical elements of all embodiments nor to delineate the scope of any or all aspects. Instead, its purpose is to present some concepts of one or more embodiments in a simplified form as a prelude to the more detailed description that is presented herein.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates an example system, consistent with embodiments of the present disclosure.

FIG. 2 illustrates another example system, consistent with embodiments of the present disclosure.

FIG. 3 illustrates an example system with a cloud-based cluster implementation, consistent with embodiments of the present disclosure.

FIG. 4 illustrates an example operating environment including a system with a cloud-based cluster and a standalone local cluster, consistent with embodiments of the present disclosure.

FIG. 5 illustrates an example production environment including a system for an event spanning multiple venues, consistent with embodiments of the present disclosure.

FIG. 6 illustrates another example production environment including a system for a large scale broadcasting event, consistent with embodiments of the present disclosure.

FIG. 7 illustrates an example graphical user interface associated with the multipurpose control and networking platform, consistent with embodiments of the present disclosure.

FIG. 8 illustrates an example operating environment including a system with end user devices, a broadcast controller, and a software-defined network, consistent with embodiments of the present disclosure.

FIG. 9 illustrates a flowchart of an example method for utilizing a centralized resource pool to recover from an equipment fault, consistent with embodiments of the present disclosure.

FIG. 10 illustrates an example graphical user interface associated with a pathfinder component of a software-defined network, consistent with embodiments of the present disclosure.

FIG. 11 illustrates a diagram of a system including a pathfinder component for a software-defined network, consistent with embodiments of the present disclosure.

FIG. 12 illustrates a flow chart for an example method for implementing a multipurpose control and networking platform, consistent with embodiments of the present disclosure.

FIG. 13 illustrates a flow chart for an example method for dynamically connecting a plurality of networked devices for secure communications, consistent with embodiments of the present disclosure.

FIG. 14 illustrates a flow chart for an example method for providing a software-defined network, consistent with embodiments of the present disclosure.

### DETAILED DESCRIPTION

Example embodiments are described herein with reference to the accompanying drawings. The figures are exemplary and not necessarily drawn to scale.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used herein and in the appended claims, the singular forms “a,” “an,” and “the” include plural references unless the context clearly dictates otherwise.

Throughout this disclosure there are references to “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

Embodiments described herein include non-transitory computer readable medium containing instructions that when executed by at least one processor, cause the at least one processor to perform a method or set of operations. Non-transitory computer readable mediums may be any medium capable of storing data in any memory in a way that may be read by any computing device with a processor to carry out methods or any other instructions stored in the memory. The non-transitory computer readable medium may be implemented to include any combination of software, firmware, and hardware. Software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”), a memory, and input/output interfaces. The computer platform may also include an operating system and programmable instructions or code. The various processes and functions described in this disclosure may be either part of the programmable instructions or code or part of the application program, or any combination thereof, which may be executed by a CPU, whether or not such a computer or processor is explicitly shown. In addition, various other peripheral units may be connected to the computer platform such as an additional data storage unit and display devices.

Furthermore, a non-transitory computer readable medium may be any computer readable medium except for a transitory propagating signal.

The memory may include any mechanism for storing electronic data or instructions, including Random Access Memory (RAM), a Read-Only Memory (ROM), a hard disk, an optical disk, a magnetic medium, a flash memory, other permanent, fixed, volatile or non-volatile memory. The memory may include one or more separate storage devices collocated or disbursed, capable of storing data structures, instructions, or any other data. The memory may further include a memory portion containing instructions for the processor to execute. The memory may also be used as a working memory device for the processors or as a temporary storage.

Some embodiments may involve at least one processor. “At least one processor” may constitute any physical computing device or group of devices having electric circuitry that performs a logic operation on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), servers, virtual servers, or other circuits suitable for executing instructions or performing logic operations. The instructions executed by at least one processor may, for example, be pre-loaded into a memory integrated with or embedded into the controller or may be stored in a separate memory.

In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically, or by other means that permit them to interact.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

In the following description, various working examples are provided for illustrative purposes. However, it is to be understood the present disclosure may be practiced without one or more of these details. Reference will now be made in detail to non-limiting examples of this disclosure, examples of which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor. It is to be understood that this form of disclosure is for ease of discussion only, and one or more aspects of one embodiment herein may be combined with one or more aspects of other embodiments herein, within the intended scope of this disclosure.

Consistent with the present disclosure, some implementations may involve a network. A network may constitute any combination or type of physical and/or wireless computer networking arrangement used to exchange data. For example, a network may be the Internet, a private data network, a virtual private network using a public network, a Wi-Fi network, a mesh network, a local area network (LAN), a wide area network (WAN), and/or other suitable connections and combinations that may enable information exchange among various components of the system. In some implementations, a network may include one or more physical links used to exchange data, such as Ethernet, coaxial cables, twisted pair cables, fiber optics, or any other suitable physical medium for exchanging data. A network may also include a public, wired network and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between separate entities.

In some implementations, machine learning algorithms may be trained using training data. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by a process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters. The machine learning algorithms may be further retrained based on any output.

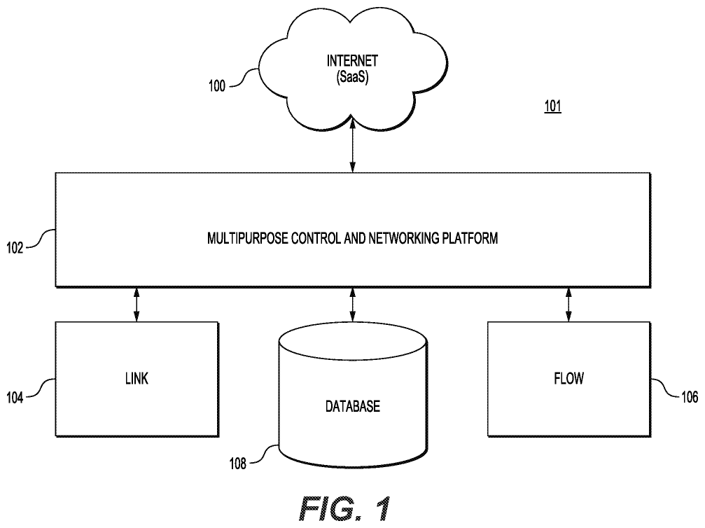

Disclosed embodiments may provide an interface or platform for users and/or devices to access software as a service (“SAAS”) products through unified technology-based solution with a common interface and/or front-end graphical user interface. Disclosed embodiments may include combinations of service solutions and components. For example, some embodiments include: (i) a Produce service solution, (ii) a Share service solution, and (iii) a multipurpose control and networking platform. The Produce solution may provide an infrastructure, methods, and a workflow to determine cloud production and centralized production. In some embodiments, the Produce solution may be implemented as a hub and spoke service solution. The Share solution may provide a service and system (including one or more databases) for storing and distributing content. In some embodiments, the Share solution may be implemented as a media bank service solution. The multipurpose control and networking platform (see, e.g., 102 in FIG. 1) may exist as a standalone set of application(s) that may also function as part of a cloud platform infrastructure. In some embodiments, the multipurpose control and networking platform is a deployable package and service that acts as the functional platform for equipment state management. The multipurpose control and networking platform may also manage all configurations and features.

FIG. 1 illustrates an example system 101, consistent with embodiments of the present disclosure. As illustrated in FIG. 1, system 101 includes a computer-implemented multipurpose control and networking platform 102. The multipurpose control and networking platform 102 may include one or more computer-implemented services, such as a service, Flow 106, that is configured to dynamically connect devices for secure communications. For example, Flow 106 may be configured to connect a plurality of networked devices to a broadcast controller. Flow 106 may provide secure connections and redundancy for each device or node that is connected. Embodiments for providing such connections are further described herein with reference to the other drawings.

Other services may be provided by the multipurpose control and networking platform 102. For example, one or more software-defined networking services may be provided, such as Link 104. Link 104 may include software defined networking features and processes to provide full control and isolation of a device network that exists locally at an event or operating environment and also across the Internet. Example embodiments of software-defined networking services are provided herein, consistent with the present disclosure. Additional examples of computer-implemented service solutions that may be provided with or supported through multipurpose control and networking platform 102 include services for managing and distributing content (e.g., video, audio, multi-media, etc.). For instance, a Share service solution (not shown in FIG. 1) may be provided to manage and distribute content to end users, as well as the metadata related to such content. Such a service may also support the configuration and/or procedures that affect the distributed content. As a still further example, a Produce service solution (not shown in FIG. 1) may be provided to manage data centers, facilities, and/or telecommunications as part of a production. Such a service may enable the interconnected operation of shows or other events beyond a single location, for example.

Referring again to FIG. 1, the multipurpose control and networking platform 102 may be connected to one or more networks, such as the Internet 100. With such networks, one or more cloud-based services may be hosted (e.g., as Software as a Service or “SaaS”). Through the Internet 100 and/or other networks, one or more users and/or devices (not shown in FIG. 1) may be connected to computer-implemented multipurpose control and networking platform 102. As further shown in FIG. 1, multipurpose control and networking platform 102 may also be connected to one or more databases 108. Databases 108 may store and distribute content and applications for a plurality of connected networked devices. In some embodiments, database 108 may comprise a media bank for storing digital assets or multi-media content. In some embodiments, databases 108 comprise one or more of an image repository, a metadata store, a configuration store, and/or a scheduling database.

Embodiments of the present disclosure may dynamically connect devices for secure communications. As disclosed in the example of FIG. 1, this may be achieved through a computer-implemented service or solution such as Flow 106. Such a service may dynamically connect devices for secure communications through an endpoint input and output solution, with all devices and/or users may connect through the solution. In some embodiments, each connection is managed, isolated, and redundant, and is done so by software-defined networking services or solutions. In some embodiments, devices and/or users may connect, but only devices and/or users that are authorized or assigned may have the ability to detect and communicate with each other. In some embodiments, software-defined networking services (e.g., Link 104) may provide a customized software defined network. In the example of FIG. 1, software-defined networking solutions 104 may allow the multipurpose control and networking platform 102 to function seamlessly and transparently for users or devices by dynamically adapting at least one of a service solution or feature running on connected networked devices. Further features, aspects, and embodiments related to systems and services 102, 104, 106 of FIG. 1 are provided below.

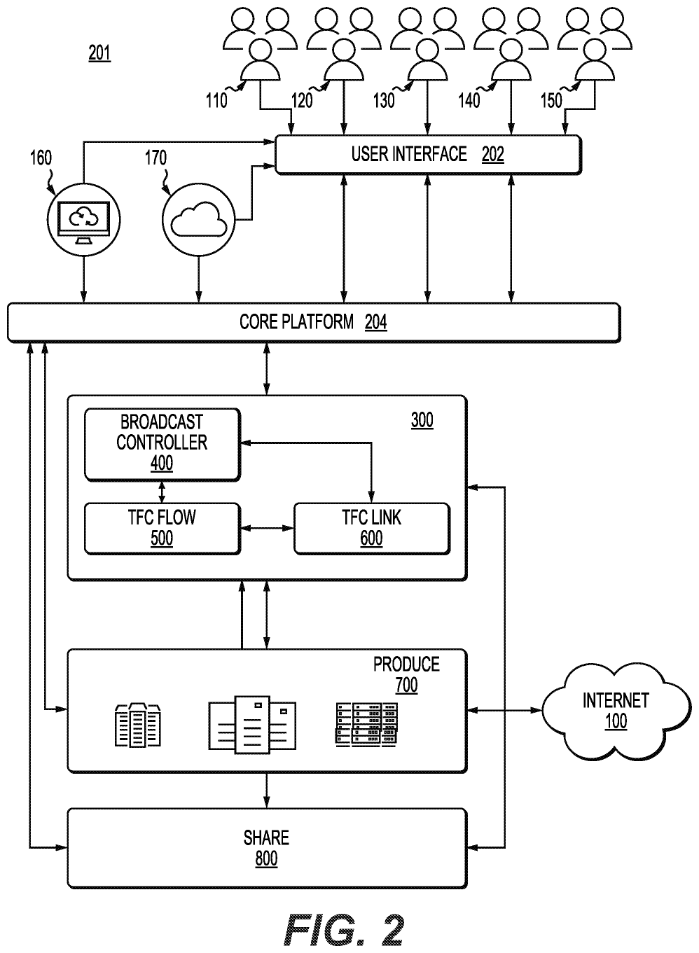

FIG. 2 illustrates another example system 201, consistent with embodiments of the present disclosure. The example system 201 of FIG. 2 may be implemented to provide a centralized production platform for digital media and/or entertainment services. It will be appreciated that other services and solutions may be provided with the system. Users (e.g., users 110, 120, 130, 140, and 150) may connect to user interface 202. As illustrated in FIG. 2, users may refer to service users or support users associated with or administering the production environment and connected devices and platforms therein. User interface 202 may support one or more connections to a Core platform 204 to access the methods and features of the disclosed embodiments. In addition, one or more devices and/or data sources (160, 170) may be connected to user interface 202 or to Core platform 204. In some embodiments, Core platform 204 may be implemented as a gateway or an interface for users, devices, and/or data to access and obtain the services or solutions of multipurpose control and networking platform 300. As illustrated in FIG. 2, users, networked devices, and various data (e.g., audio, video, and/or multimedia) may be connected to the system through different entry points (e.g., endpoints).

As further shown in FIG. 2, the system 200 may include: (i) Produce 700, (ii) Share 800, and (iii) multipurpose control and networking platform 300. Produce 700 may provide a computer-implemented service solution including the infrastructure, methods, and a workflow to support cloud production and/or centralized production. In some embodiments, Produce 700 may provide a hub and spoke service solution. Share 800 may provide a computer-implemented service solution using one or more databases (not shown) for storing and distributing content (e.g., video, audio, multimedia, etc.). In some embodiments, Share 800 is implemented as a media bank service solution. In some embodiments, multipurpose control and networking platform 300 may be implemented through a standalone set of application(s) (e.g., a standalone local cluster) and also function as part of a cloud platform infrastructure (e.g., a cloud-based cluster or service). In some embodiments, multipurpose control and networking platform 300 is a deployable package and service that acts as the functional platform for equipment state management. It may also monitor and control all deployments, configurations, service solutions, and features.

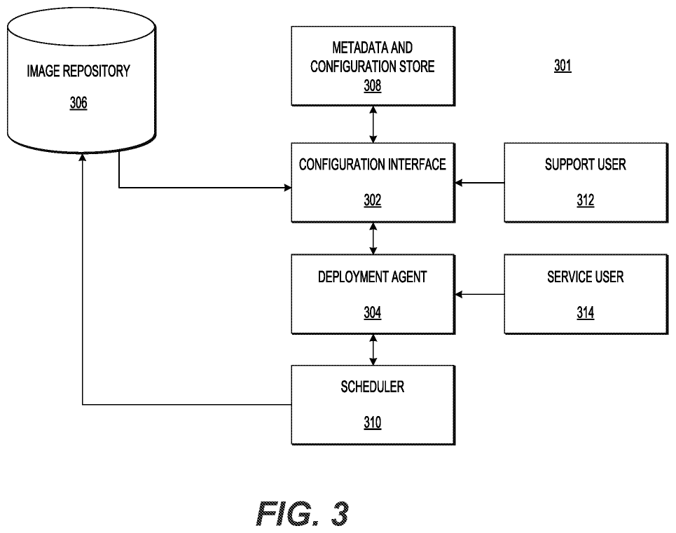

In some embodiments, platform 300 may include broadcast controller 400, Flow 500 that provides services for dynamically connecting devices for secure communications, and Link 600 that provides software-defined networking services or solutions. Broadcast controller 400, Flow 500, and Link 600 may all connect and communicate with one another as well as with other systems and applications. As shown in FIG. 2, platform 300 may also be connected with Produce 700 and Share 800, each of which is accessible to one or more networks, such as the Internet 100. Further embodiments of the present disclosure are described herein with reference to FIGS. 3-14.

Disclosed embodiments may provide a multipurpose control and networking platform (e.g., 102 of FIG. 1 and 300 of FIG. 2) and software with capabilities for mixed master/multi-master control of a single system or multiple systems. The multipurpose control and networking platform of the present disclosure may be implemented with at least one processor and an executable software engine to configure, monitor, and control facilities and networked devices. Advantageously, it may allow for technology-agnostic deployment of software solutions or features from one unified system or multiple integrated systems. For example, mobile units (e.g., production trucks including a technical hub), which are Internet Protocol or IP-based, may utilize the multipurpose control and networking platform's innovative and scalable platform for various types of events. The multipurpose control and networking platform (e.g., 102 of FIG. 1 and 300 of FIG. 2) may be deployed in mixed scenarios. For example, the multipurpose control and networking platform may be deployed in a traditional manner in an entirely on-site workflow (e.g., at a single location). In another example, the multipurpose control and networking platform may be deployed in a centralized production having local or remote components, ranging from a blended on-site and remote workflow, a remote and distributed workflow, and a virtualized workflow in a cloud environment. In the example of the virtualized workflow in the cloud environment, the multipurpose control and networking platform (e.g., 102 of FIG. 1 and 300 of FIG. 2) may provide a decentralized control using a software-based user-interface. The multipurpose control and networking platform of the present disclosure may also be deployed in a range of facilities, including a centralized production facility, mobile units, remote locations, and/or flypack facilities.

The multipurpose control and networking platform (e.g., 102 of FIG. 1 and 300 of FIG. 2) may provide much value to the facilities it connects. For example, the multipurpose control and networking platform may operate as a unified, feature rich platform that brings together all systems, facilities, networks, and the cloud environment together in one place. Through smart design and automations, the multipurpose control and networking platform streamlines workflows and removes complexity by automating, speeding, and simplifying configuration and management of facilities, features, and devices. The multipurpose control and networking platform (e.g., 102 of FIG. 1 and 300 of FIG. 2) may also provide for secure communication (e.g., via a control panel) by methods of assignation or authentication that may control media flow and device orchestration. The multipurpose control and networking platform may also provide an intuitive, elegant user interface to allow for independent control. The multipurpose control and networking platform of the present disclosure may also be technologically agnostic and may connect with any common broadcast device, regardless of make, model, baseband, or other capabilities or requirements of the device.

Embodiments of the present disclosure may provide a single, easy-to-use touchpoint to configure, provision, monitor, and control equipment across facilities, features, and devices. This allows for multiple disparate systems to act as one unified platform, making highly complex setups seamless and simplified. Examples of features that may be deployed may include device configuration and control, IP routing, software defined networking, systems and network monitoring, rules-based audio and video alignment, resource scheduling and sharing, network and device security, infinitely scalable multi-viewers, workflow automation, user management, and cloud production functionality.

Disclosed embodiments may be implemented in a wide range and number of production environments, hubs, and locations. The multipurpose control and networking platform (e.g., 102 of FIG. 1 and 300 of FIG. 2) may be implemented at one or more production spaces (e.g., hubs or locations) and act independently at each hub and location or act as one unified system to provide high-quality, zero delay or latency production, and total creative control. Disclosed embodiments may provide flexibility to connect agnostic technologies and services to match production needs. Examples of production locations and spaces may include control rooms, edit suites, remote operator facilities, studios, virtual studios, green screen studios, and voiceover and commentator spaces. Disclosed embodiments may provide an end-to-end suite of solutions. Examples of end-to-end suite of solutions may include media bank media asset management, remote commentary, virtualized editing, graphics and augmented reality solutions, ingest, storage, localization, streaming, transmission, connectivity, logistics and project management, production services and crewing, and other creative services.

Disclosed embodiments may provide a multipurpose control and networking platform (e.g., 102 of FIG. 1 and 300 of FIG. 2) that allows for easy, rapid technology-agnostic deployment, configuration, and monitoring of software solutions or features. For example, the proprietary multipurpose control and networking platform may provide a complete range of end-to-end solutions deployed via technical hubs, connected broadcasting devices, networking devices, or nodes.

Disclosed embodiments provide computer-implemented service solutions for dynamically connecting networked devices for secure communications (e.g., Flow 106 of FIG. 1 and Flow 500 of FIG. 2). Disclosed embodiments may dynamically connect devices for secure communications through an endpoint input and output solution and all devices and/or users may connect through the endpoint input and output solution. Each connection may be managed, isolated, and redundant, and is done so by defined networking solutions. Devices and/or users may connect, but only devices and/or users that are assigned to have the ability to detect and communicate with each other. Assigning may refer to registering, authorizing, authenticating, or otherwise meeting a threshold parameter or condition to validate a connected device or user thereof. Each location deployment may include at least one primary node and at least one secondary node. An example of an event network may be a live event network, a broadcast network, a streaming network, or a recording network. Other types of nodes or additional nodes may be used as well. Examples of other nodes may include a second primary node, multiple primary nodes, additional secondary nodes, and throwdown nodes. The at least one primary node may enable an event network by connecting to a broadcast controller and to at least one other node or broadcasting device. Various nodes or node types may be deployed to capture signals throughout one or more locations having broadcasting devices, and to transmit the captured signals from the broadcasting devices to a connected broadcast controller, to other technical hubs, or to a multipurpose networking and control platform (e.g., 102 of FIG. 1 and 300 of FIG. 2). Nodes may be connected within each location or across multiple locations to further connect networked devices at each location with a broadcast controller, other technical hubs, or platforms. An example of node connections within each location include connections that utilize mesh network technology. The mesh network technology or other node network technology may be implemented with connection providing redundant red and blue paths for broadcasting and other services. Nodes from multiple locations may also be connected via point-to-point networking, operating as one unified system. Alternatively, nodes from multiple locations may not be connected and may act independently. Disclosed embodiments may scale up and down, based, e.g., on the nodes and networking devices implemented, to handle as many data signals, broadcasting devices, and locations as appropriate. Disclosed embodiments may provide a powerful, easy-to-use, digital content management software that controls all data, intercom, and video and audio signals within a unified event network.

Disclosed embodiments may provide an endpoint system that uses both proprietary and commercial off-the-shelf hardware/software. Disclosed embodiments may act as a gateway for device and/or user interfacing. Devices that are dynamically connected by disclosed embodiments may operate as an input, an output, or both concurrently. By dynamically connecting devices for secure communications (e.g., via Flow 106 of FIG. 1 or Flow 500 of FIG. 2), disclosed embodiments may provide security and authentication by assigning connected devices as validated endpoint devices and registering unique identifiers for each validated endpoint device. Proprietary endpoint devices may be automatically identified and assigned and function automatically within disclosed embodiments. Non-proprietary endpoint devices may be registered manually and/or automatically by the unique identifiers or by assigning the non-proprietary endpoint devices. Because the system is technologically agnostic, all valid devices may be registered and assigned seamlessly without requiring various scripts or updates associated with different technologies to enable them to be used together. Endpoint devices will function within disclosed embodiments as designated, and any interruptions of signals between the endpoint devices and the multipurpose control and networking platform may be recognized by disclosed embodiments or reported. Further, interrupted endpoint device signals may be automatically rerouted to prevent network interruption for disclosed embodiments and/or other endpoint devices. Disclosed embodiments may also identify and reroute intrusions into the network outside of assigned endpoint devices. These identified intrusions may also be reported to a user or administrator. Disclosed embodiments may prevent intrusions from affecting and/or compromising user experience. Endpoint devices may connect to the multipurpose control and networking platform either through a single connection or through multiple redundant connections when multiple connections are present to the endpoint device.

Disclosed embodiments may provide software-defined networking service solutions. The software-defined networking service solutions (e.g., Link 104 of FIG. 1 and Link 600 of FIG. 2) may be computer-implemented and provide customized software defined networking solutions. Software-defined networking solutions may allow the multipurpose control and networking platform to function seamlessly and transparently for users and/or devices. In some embodiments, the software-defined networking solutions may be comprised of features and processes that grant full control and isolation of device networks that exist concurrently both locally and across the Internet 100.

By way of example, the software-defined networking solutions of the present disclosure may provide discovery services, instantiation services, automatic adjustment services, and reporting services. Disclosed embodiments may constantly monitor and/or scan connections for connected devices. Disclosed embodiments may recognize when new devices are added, when existing devices are added, and when existing devices are removed. Further, disclosed embodiments may automatically adjust connections to reflect the added or removed device as the change occurs. Once connected, devices are assigned to one or more systems or services of the disclosed embodiments. If the device has not been previously assigned, it will remain isolated in an active queue pool for as long as it is connected or until it is properly authenticated, and provisions are made to bring the device into an active role. Each device may be associated with a tag, resource allocation information, and/or a resource allocation definition. Examples of the resource allocation information or definition may include a configuration state, an address, a use definition, a configuration profile, a functionality preset, and an active role. The tag or resource allocation information or definition may be used to determine the devices' location, network address, level of security, and other capabilities or attributes that are associated with the device. In some embodiments, the software-defined networking solutions (e.g., Link 104 of FIG. 1 and Link 600 of FIG. 2) may be deployed as multiple instances running across multiple linked networks or servers. Alternatively, the software-defined networking solutions may operate standalone as a single instance on a network. When multiple instances of software-defined networking solutions are deployed within a network infrastructure, the solutions may track and report to one another to provide both redundancy and load distribution.

Embodiments of the present disclosure include computer-implemented systems and methods for a multipurpose control and networking platform. In some embodiments, a system is provided that includes a plurality of networked devices. The networked devices may include broadcasting devices, networking devices, and/or any combination thereof. Broadcasting devices include equipment, devices, and systems configured to capture, store, convert, or transmit audio, video, and/or other data (e.g., metadata) signals. Such signals may be transmitted to a wide audience, or at least to multiple recipients, simultaneously via a broadcast controller. Broadcasting devices may include television broadcasting devices (e.g., television transmitters or cameras), radio broadcasting devices (e.g., radio transmitters or microphones), Internet broadcasting devices (e.g., webcams, video cameras, or software encoders that transmit the content captured by the webcams, video cameras, or other end device capturing data), and/or data broadcasting devices (e.g., devices used for transmitting updates or network information to end devices). Networking devices include equipment, devices, and systems configured to facilitate secure communications and the exchange of data or signals between the plurality of networked devices. Such networking devices may comprise suitable combinations of hardware, software, and/or mixed hardware-software components. In some embodiments, the networking devices may support communications and the exchange of data or signals by and between networked devices and other devices or systems, such as the broadcast controller and multipurpose control and networking platform. In some embodiments, the networking devices may establish and maintain network connections, enable data transfer, and/or ensure the efficient operation of the disclosed system. Examples of networking devices include routers, switches, hubs, access points, modems, firewalls, load balancers, gateways, network bridges, and proxy servers. In some embodiments, the broadcasting devices and the networking devices may be implemented as on-site devices and/or remote devices. On-site devices include devices that are located physically at a specific physical location or site. Remote devices include devices that are hosted or operated in a location that is remote or separate from the specific physical location or site. In some embodiments, remote devices are located in a centralized data center or resource pool.

The plurality of networked devices may be dynamically connected for secure communications with at least one processor (e.g., at least one processor of 102, 104, or 106 of FIG. 1 or at least one processor of 300 of FIG. 2). The at least one processor may be configured to configure at least one of a service solution or a feature. In some disclosed embodiments, the service solution may comprise at least one of a software-enabled networking solution, a centralized production, a cloud production, a live production, a broadcasting production, or a live streaming event. In some disclosed embodiments, the feature may comprise at least one of a device configuration, a device control, an IP routing, system and network monitoring, a rules-based audio and video alignment, a resource schedule, resource share, network and device security, scaling, workflow automation, user management, or cloud production functionality. The at least one processor may also be configured to deploy, among the plurality of networked devices, at least one of the service solution or the feature using one or more standalone local clusters for the plurality of networked devices. A cluster may refer to a group of interconnected or coordinated container instances that work together to provide a specific service, function, or application. Clusters may be managed by a container orchestration platform connected to or embedded within the multipurpose control and networking platform (e.g., 102 of FIG. 1 and 300 of FIG. 2). A local cluster includes a cluster that is created and run on a single machine (e.g., a single networked device) or in an environment associated with the single machine, as opposed to, e.g., a cloud-based cluster that may span multiple machines or nodes. A standalone local cluster includes a local cluster that operates independently and that does not interact with or rely on other clusters or systems. Standalone clusters may be self-contained and may serve a specific purpose or application without the need for external coordination or communication (e.g., coordination or communication via the multipurpose control and networking platform). In some embodiments, the one or more standalone local clusters may be configured to operate without being dependent on external data sources, servers, or applications, and in an absence of Internet connectivity to, e.g., other clusters or to the multipurpose control and networking platform (e.g., 102 of FIG. 1 and 300 of FIG. 2).

The at least one processor (e.g., at least one processor of 102, 104, or 106 of FIG. 1 or at least one processor of 300 of FIG. 2) may also be configured to monitor and control the deployment of at least one of the service solution or the feature. In some embodiments, monitoring by the at least one processor may include collecting data during the deployment of the at least one service solution or feature. Collected data may include information associated with the deployment or the networked device, such as performance metrics, log information, configuration data, connected device data, associated tag information, metadata, or other data reflective of the status, operation, configuration, or history of the deployment or networked device. Monitoring may further include processing the collected data to determine a current status of the deployment or networked device, a previous status of the deployment or networked device, or a predicted future status of the deployment or networked device, and generating an alert based on any abnormal determined status. By monitoring each deployment or device, a user or administrator may gain insights into the performance of the deployment or device, detect issues and errors before they become critical, and take proactive measures to optimize the operation of the deployment or device. The monitoring infrastructure may be a collection of tools and components that work together to collect, store, process, and visualize metrics and other data from a container environment. Monitoring may provide a way to assess the health and performance of each deployment or device, including the services, features, and applications running thereon. For example, by analyzing the metrics and logs generated by the deployments or devices, the monitoring infrastructure can help identify trends, track changes, and diagnose issues. The monitoring infrastructure may also be used for identifying and addressing performance and availability issues in a timely manner, helping to minimize downtime and prevent outages. It can also provide valuable insights into the usage patterns and behavior of the container environment, which can help optimize resource allocation, capacity planning, and scaling.

In some embodiments, determining a status or generating an alert may lead the at least one processor to control the deployment. In some embodiments, controlling the deployment may include associating endpoints from a centralized resource pool with networked devices based on one or more productions, and segregating (e.g., isolating) the endpoints or networked devices based on the one or more productions. Controlling the deployment may also include re-arranging connections between networked devices in response to a detection of a new connected device, a removed device, or a failing network component, so as to maintain proper data flow between end devices (e.g., a camera and a user viewing the broadcast) by making any necessary changes to a cluster based on the detection. A centralized resource pool may refer to a collection or grouping of available and assigned broadcasting devices, networking devices, or other computing resources, such as processors, memory, storage, or network bandwidth, that is aggregated and made available for allocation to various applications, clusters, services, or features. An endpoint may refer to a single resource available in the centralized resource pool.

In some embodiments, the at least one processor (e.g., at least one processor of 102, 104, or 106 of FIG. 1 or at least one processor of 300 of FIG. 2) may further be configured to automate, based on a schedule, routing paths of the at least one of the service solution or the feature between the plurality of networked devices, the endpoints from the centralized resource pool, and the multipurpose control and networking platform. Routing paths may refer to the sequences of nodes or other connections that data packets follow when traveling from a source (e.g., a networked broadcasting device, or a user device) to a destination (e.g., the multipurpose control and networking platform, or another user device), or vice versa, in a network. For example, a routing path may include a broadcasting device, one or more networking devices, one or more nodes, multipurpose control and networking platform (e.g., 102 of FIG. 1 and 300 of FIG. 2), and the connections therebetween. An additional (e.g., redundant) routing path may include the same components but having different networking devices or nodes. A scheduling component of the multipurpose control and networking platform may allow for services or features to be configured or removed at specific times, based on, e.g., a production environment schedule. For example, the scheduling component may have access to a production environment schedule spanning a period of time, and based on the schedule, the scheduler component may delegate specific devices or connections for deployment. The scheduling component may further enable an authorized user or administrator to approve a scheduled configuration or removal before the process is executed. The scheduling component may further automate routing, re-routing, and service provisioning based on a calendar of events associated with one or more production environments. The calendar may be synchronized with additional production scheduling systems or applications. The scheduling component may also be used to generate reminders or alerts or plan actions for a future time period based on the calendar or a sequence of planned events.

In some embodiments, a cloud-based cluster or multiple cloud-based clusters may be connected to the standalone local cluster via secure connections and at least one application programming interface or API. A cloud-based cluster may include to a cluster of interconnected computing resources and services (e.g., container instances) hosted in a cloud computing environment. The cloud-based cluster may be configured to be aware of all available and configurable service solutions and features, as well as which versions exist or which updates are available. As a result, multipurpose control and networking platform (e.g., 102 of FIG. 1 and 300 of FIG. 2) may comprise a multi-pronged service including centralized cloud-based component(s) (e.g., cloud-based cluster(s)) and local component(s) (e.g., local cluster(s)) associated with each networked device. Each local component may be associated with multiple networked devices, nodes, mobile units, or technical hubs. Additionally, or alternatively, each local component may be assigned, installed, configured, or updated based on information received from the cloud-based component. In some embodiments, each local component may also function as a standalone local cluster (e.g., after assignment, installation, configuration, or updates are implemented). As a result, a user may, via, e.g., a user interface associated with the local cluster, start, pause, stop, or restart connected networked devices or the local component as a whole or in part, based on user-desired services or functions or services or functions based on a production schedule (e.g., device-specific, data flow, routing, category-based, tag-based, multiviewer, production-based, state-based, resource-based, or driver-based services or function). The local component may operate without requiring further information or resources from the cloud-based component. The local component may thus provide an reliable and speedy startup and shutdown procedures for technical hubs or devices, particularly those which are mobile and thereby may need to operate without a continuous live connection to the cloud-based component or without dependencies on other services, databases, or connections. The cloud-based component may further be connected to a repository (e.g., a code repository) which the cloud-based component scans (either continuously or periodically) to identify new versions or updates to services or features, as input into the repository by developers of the services or features. The repository may store the source code and programming for the multipurpose control and networking platform, which may be maintained and consistently updated by an active development team. Furthermore, the cloud-based component may expose any identified updates or new configuration data via at least one application programming interface (API). By connecting to the at least one API, the local cluster may receive the updates or new configuration data when connectivity with the cloud-based component is (re-)established and redeploy the service or feature with the updates or new configurations. As a result, installing a new service or feature, or updating a service or feature, onto a local cluster may occur with ease via the cloud-based component and the at least one API. Another advantage provided by the one or more standalone local clusters is that configurations associated with particular networked devices or users may be stored on corresponding standalone local clusters. As a result, devices or technical hubs do not reset as a result of a shutdown (e.g., a planned shutdown or an unexpected shutdown), and upon restart, the components of the devices or technical hubs may restart in a proper order without requiring additional or repeat input. For example, the local cluster may have a predetermined procedure for startup and shutdown, wherein containers embodying microservices associated with the components of the devices or technical hubs are scaled either up or down in proper order to match the installation and configuration data (including any updates) stored on the local cluster. As a result, a local cluster may enable clean and seamless startup and shutdown procedures for any devices, services, or features associated with the local cluster on demand or in response to an unexpected failing device or component, all without requiring connectivity with the cloud-based cluster or other external sources or applications.

In some embodiments, monitoring and controlling the deployment may comprise at least one of receiving data from a cloud-based cluster and transmitting the received data to the one or more standalone local clusters. The one or more standalone clusters may then act on the received data to deploy a new service or feature or update a running service or feature. In some embodiments, monitoring and controlling the deployment may comprise receiving other data from the one or more standalone local clusters and transmitting the received other data to the cloud-based cluster. The cloud-based cluster may thus receive, store, and process data from the standalone cluster for purposes of further monitoring and control. In some embodiments, the cloud-based cluster or the local cluster may contain multiple masters and multiple worker nodes. In the event of a failure of any given node, the cluster may resolve the failure automatically by redistributing the affected containers to other functioning nodes or networking devices. The clusters may also comprise containers based on microservices. A microservices architecture allows for further fault tolerance by having individual components run as independent microservice instances such that in the event of a failure of one microservice instance, another microservice instance may quickly and automatically replace the failing instance such that the cluster remains operational without disruption. Additionally, multiple instances of a service or feature may run simultaneously on a cluster allowing, e.g., the processing of requests to be load-balanced and distributed across multiple nodes of the multiple instances to further increase availability of resources and efficiency of the cluster.

FIG. 3 is a diagram of an example computer-implemented system 301 with a cloud-based cluster implementation, according to disclosed embodiments. System 301 may include configuration interface 302 and deployment agent 304. Configuration interface 302 may be connected to image repository 306, metadata and configuration store 308, and deployment agent 304. Image repository 306 may store various templates (e.g., machine images) corresponding to various operating or computing systems which may be compatible with or utilized by various devices or resources of a production network. Deployment agent 304 may be configured to deploy service solutions or features, configure the deployments, provision the deployments, and monitor the deployments. Deployment agent 304 may be further connected to scheduler 310. Scheduler 310 may be configured to store and provide event scheduling information or event runtime information to deployment agent 304. Scheduler 310 may be further connected to image repository 306, which may be configured to provide access to scheduler 310 such that scheduler 310 may retrieve images from image repository 306. Configuration interface 302 may be configured to receive configuration and update information from a support user 312 (e.g., a user connected via controller interface 302 who may administratively configure services or approve updates to deployed services or features), to access image data stored in image repository 306, or to access metadata or configurations stored in metadata and configuration store 308. Configuration interface 302 may thus enable communication between support user 312 and image repository 306 or metadata and configuration store 308. For example, configuration interface 302 may enable the selection and pulling of a machine image stored in image repository 306, the selection and pulling of metadata or configurations associated with the selected machine image and stored in metadata and configuration store 308, and the requesting of a deployment or updating of at least one of a service solution or a feature via deployment agent 304. Deployment agent 304 may be configured to receive input from a service user 314 (e.g., a user of a deployed service or feature, or a user of a connected device), receive service state information or status updates from scheduler 310, receive metadata, configuration data, or image data via configuration interface 302, or forward status updates from scheduler 310 to configuration interface 302. Deployment agent 304 may thus enable communication between service user 314, configuration interface 302, and scheduler 310. For example, deployment agent 304 may enable the deployment of at least one of a service solution or feature (or an update of the deployment) based on input received from service user 314. The deployment may be configured and provisioned based on, e.g., image data from image repository 306, as pulled by scheduler 310, metadata or configuration data from metadata and configuration store 308, as pulled by configuration interface 302, or scheduling information from scheduler 310, as pulled by deployment agent 304. In some embodiments, rather than being a component of the cloud-based cluster, deployment agent 304 may be deployed as at least part of a standalone local cluster associated with one or more connected networked devices or at least one deployed service solution or feature.

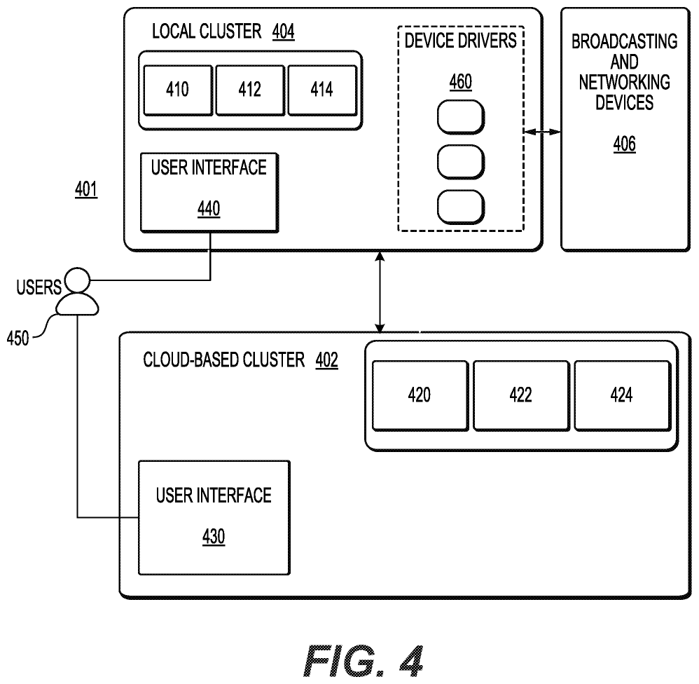

FIG. 4 is a diagram of an example operating environment including a computer-implemented system 401 with a cloud-based cluster 402 and a standalone local cluster 404. Cloud-based cluster 402 may include container instances 420, 422, 424 with microservices for configuring at least one of a service solution or feature, deploying the at least one service solution or feature, monitoring the at least one service solution or feature, and controlling the at least one service solution or feature. Standalone local cluster 404 may include container instances 410, 412, 414 with microservices associated with operating a set of connected devices 406 or deploying at least one of a service solution or feature, wherein the container instances are configured based on the particular needs of any detected connected devices 406. When connectivity between cloud-based cluster 402 and standalone local cluster 404 exists, cloud-based cluster 402 may push new information (e.g., configuration data, metadata, update data, scheduling data) to standalone local cluster 404 (e.g., via at least one API). Based on the new information received, standalone local cluster 404 may be modified to implement the new information by e.g., adding, removing, scaling, or otherwise modifying the container instances 410, 412, 414 therein. Standalone local cluster 404 may also be connected to a plurality of networked devices 406 (e.g., broadcasting devices or networking devices) which form the production network at a particular location or across locations. Standalone local cluster 404 may also include device drivers 460 for any number of potential connected devices thus enabling local cluster 402 to be technologically agnostic with respect to the type or requirements of connected devices 406. The plurality of networked devices 406 may, in turn, be monitored and controlled via standalone local cluster 404 and based on the information received (e.g., at least periodically) from cloud-based cluster 402. Standalone local cluster 404, however, may also operate independently of cloud-based cluster 402 and without reliance on the container instances 420, 422, 424 of cloud-based cluster 402, e.g., during its monitoring or controlling of the plurality of networked devices 406. Users 450 may connect to the cloud-based cluster 402 via user interface 430 and to the local cluster 404 via user interface 440.

In some disclosed embodiments, the deployment among the plurality of networked devices or the monitoring and controlling of the deployment may be technologically agnostic as to the type or capabilities of each networked device or each resource utilized in connection with each networked device. Technological agnosticism refers to flexibility, adaptability, or compatibility with various technologies and solutions from various vendors or providers (e.g., without being dependent on or biased toward any specific technology, platform, programming language, hardware, or software). Agnostic may also refer to the lack of any requirement of a particular system, provider, developer, or platform for compatibility or functionality purposes. Technological agnosticism may thus allow for the development of reusable logical parts or components that can be used across different types of applications. For example, many components of a technologically agnostic framework may be re-used without requiring changes across different underlying provider frameworks and without requiring changes across different types of applications, services, or features (e.g., HTTP server frameworks, microservices with different transport layers, or Web Sockets). An exemplary system, consistent with embodiments of the present disclosure, may be flexible and independent in terms of compatible providers, tools, and platforms. With such flexibility, users or administrators are not required to adapt their devices, services, features, or programming to be compatible with a single software provider, switch provider, framework, or platform. Instead, users or administrators may connect, configure, or assign their connected devices as needed (e.g., to the broadcast controller or the multipurpose control and networking platform), based on, e.g., general requirements and conditions, rather than on the requirements of each particular service solution or feature. As such, the system may enable broadcasting productions that implement various software components or requirements, without requiring multiple frameworks or multiple scripts based on components which are incompatible.

In some embodiments, the at least one processor may be further configured to provide configuration data or control data over at least one application programming interface (API). Configuration data may refer to a set of parameters, settings, or variables that define the behavior, properties, and characteristics of a system, software application, service, feature, or device. Control data may refer to data or instructions that dictate the operation, management, or control of a system, application, service, feature, or process. Providing configuration data or control data may include emitting data through at least one API to one or more endpoints or devices which may access the data via the at least one API. In some embodiments, the data may be emitted through multiple APIs, wherein each API corresponds to a particular service solution or feature. In some embodiments, the at least one processor may provide configuration or control data continuously over at least one API, such that a newly connected networked device, upon identification, may be immediately configured by receiving and capturing emitted configuration or control data via the at least one API. As another example, the at least one processor may provide configuration or control data periodically (e.g., once every 30 seconds, once every minute, once every half hour, etc.), such that a newly connected networked device may be configured shortly after identification by receiving the emitted configuration or control data via the at least one API, during the period when it is provided but without wasting resources utilized by the at least one processor when emitting the configuration or control data.

In some embodiments, the at least one processor may further be configured to generate a visualization via a user interface, the visualization indicating statuses or parameters associated with the plurality of networked devices. The generated visualization may aid a producer, technician, or other user in monitoring the plurality of networked devices, identifying faulty equipment, or making a modification to one or more networked devices or connections therebetween.

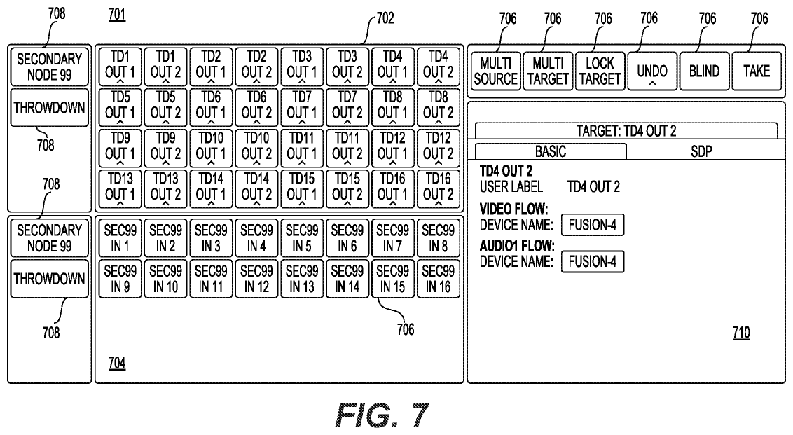

FIG. 7 shows an example graphical user interface 701 that may be provided for the multipurpose control and networking platform, consistent with disclosed embodiments. Graphical user interface 701 may be generated and implemented, e.g., via 102 of FIG. 1 or via 300 of FIG. 2. Further, graphical user interface 701 may be made accessible via network(s), e.g., via Internet 100 of FIG. 1 and/or user interface 202 of FIG. 2. Graphical user interface 701 may be accessed by, e.g., users 110, 120, 130, 140, 150, 160 of FIG. 2. Users may thus be enabled to provide inputs to cause the dynamic adapting of service solutions or features provided via, e.g., at least one processor of 102, 104, or 106 of FIG. 1 or at least one processor of 300 of FIG. 2. Graphical user interface 700 may include grouped listings of outputs 702 and inputs 704 associated with connected networked devices (e.g., cameras, microphones, technical hubs, screen feeds, networking devices, or other resources) or deployments which are assigned or installed within a production environment. Graphical user interface 700 may also include selectable action icons 706 for each of inputs 704 or outputs 702 associated with the connected networked devices or deployments. Selectable action icons 706 may enable user selection of particular modifications that the user desires to make to any of the listed connected networked devices. For example, a user may desire to perform one or more of editing the listed data, configuring or reconfiguring a deployment or a connected device, or viewing additional information regarding a deployment or device. Graphical user interface 700 may further group or identify different device types (e.g., TD, SEC) or node types 708 associated with each connected device (e.g., based on color or pattern schemes associated with each input 704 or output 702). Parameters 710 associated with a selected one of inputs 704 or outputs 704 may also be displayed. Graphical user interface 700 may therefore provide a user with both full visualizations of the production network and control of individual or grouped deployments or devices from a single and integrated software-based interface.

In some embodiments, the at least one processor (e.g., at least one processor of 102, 104, or 106 of FIG. 1 or at least one processor of 300 of FIG. 2) may be further configured to enable a decentralized control of the deployments via (e.g., using) a software-based user interface (e.g., a graphical user interface, as described herein). A decentralized control may refer to having authority, responsibility, or decision-making power which is distributed across various levels, entities, or user devices (e.g., using software-based user interfaces) within a system, rather than having the authority, responsibility, or decision-making power be concentrated in a central authority or a single point of control. A software-based user interface may refer to the graphical user interface or another graphical or visual representation of a software application or system (e.g., at least one of a service solution or a feature associated with at least one networked device) that allows users to interact with and control the software application or system. A software-based user interface may encompass various elements, layouts, or controls within the software which enable users to input commands, access functionality, view data, or receive feedback. Based on the input received from the user interaction with the software-based user interface, the at least one processor may, e.g., dynamically adapt a service solution or feature or control deployments of a service solution or feature.

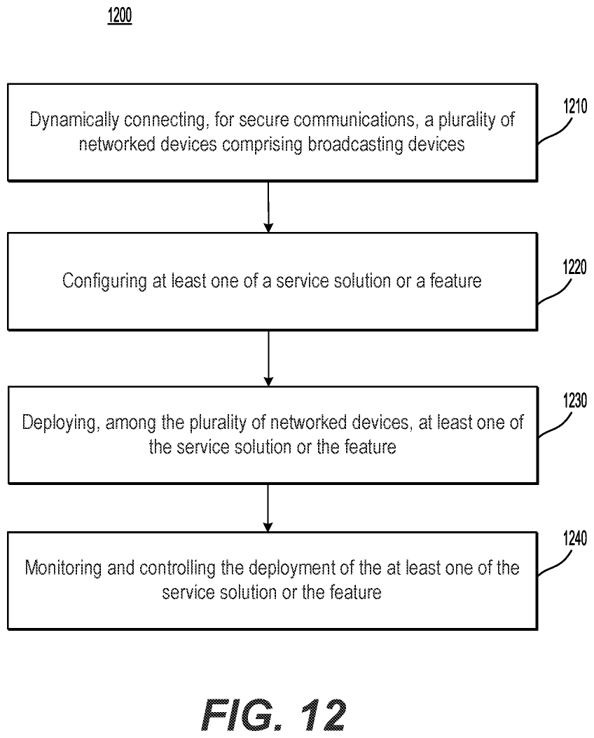

According to another embodiment of the present disclosure, a method for implementing a multipurpose control and networking platform is provided. The steps embodied in the method may be performed by at least one processor of system 101 of FIG. 1 or system 201 of FIG. 2, as described herein. Referring to FIG. 12, a flowchart is illustrated for an example method for implementing a multipurpose control and networking platform. As shown in FIG. 12, the method may start at step 1210 which includes dynamically connecting, for secure communications, a plurality of networked devices. As described, the networked devices may include broadcasting devices that are configured to transmit at least one of audio signals, video signals, or data signals. At step 1220, method 1200 may further include configuring at least one of a service solution or a feature. At step 1230, method 1200 may include deploying, among the plurality of networked devices, at least one of the service solution or the feature using one or more standalone local clusters for the plurality of networked devices. At step 1240, method 1200 may include monitoring and controlling the deployment of the at least one of the service solution or the feature.

According to yet another embodiment of the present disclosure, a non-transitory computer readable medium containing instructions that when executed by at least one processor cause the at least one processor to perform operations for implementing a multipurpose control and networking platform. The steps embodied in the instructions of the non-transitory computer readable medium may be performed by at least one processor of system 101 of FIG. 1 or system 201 of FIG. 2, as described herein. These steps may be similar to those described above with reference to the example method of FIG. 12. As such, the steps may be configured for dynamically connecting, for secure communications, a plurality of networked devices comprising broadcasting devices, the broadcasting devices transmitting at least one of audio signals, video signals, or data signals. The steps may further be configured for configuring at least one of a service solution and a feature. The steps may also be configured for deploying, among the plurality of networked devices, at least one of the service solution and the feature using one or more standalone local clusters for the plurality of networked devices. Further, the steps may be configured for monitoring and controlling the deployment of the at least one of the service solution and the feature.

Embodiments of the present disclosure further include computer-implemented systems and methods for dynamically connecting a plurality of devices for secure communications 106. In some embodiments, a system is provided that includes a plurality of devices configured for secure communications. In some embodiments, the system may include at least one primary node communicatively connected to at least one secondary node. A primary node may refer to a master node which includes a server (e.g., for connecting to the multipurpose control and networking platform), at least one network switch (e.g., for connecting to networked devices or other nodes), and a gateway device (e.g., for converting ST 2110 signals received from a networked device or another node to baseband audio and video signals). In some embodiments, the at least one primary node may be configured for connecting the plurality of networked devices to a broadcast controller. For example, the at least one network switch of the primary node may allow for the transmission of signals (e.g., captured audio or video data) from a connected device to the primary node as well as signals or data from the broadcast controller, the gateway device of the primary node may convert the received signals to baseband, and the server or the gateway device may transmit the converted signals to the broadcast controller. The server of the primary node may also transmit the converted signals to the multipurpose control and networking platform for further processing or control instructions based on the transmitted signals. A broadcast controller may refer to a hardware, software, or combined hardware-software component or application that is responsible for the distribution or transmission of broadcast content, such as television, radio, or live streaming, to a wide audience (or at least multiple recipients). A broadcast controller may be integrated with the multipurpose control and networking platform (e.g., 102 of FIG. 1 or 300 of FIG. 2) either internally within the platform or externally to operate with the platform (e.g., an external software driven broadcast controller). A broadcast controller may also be responsible for detecting, identifying, assigning, configuring, provisioning, or reporting connected networked devices (e.g., broadcasting devices, networking devices, or other devices used for a production or by a production network). A broadcast controller may further be responsible for collecting resource allocation information from the connected networked devices and sharing the collected information with a multipurpose control and networking platform (e.g., 102 of FIG. 1 or 300 of FIG. 2). A broadcast controller may also be configured to receive broadcast content from a node or from at least one component of the multipurpose control and networking platform. Broadcast content may include video data, audio data, or metadata. Further, a broadcast controller may distribute the received broadcast content through unicast or multicast networks. A broadcast controller may, e.g., ensure that broadcast content is delivered reliably, efficiently, or according to a predefined schedule to the wide audience (or at least multiple recipients) simultaneously and without interruption. In some embodiments, the broadcast controller may be connected to the multipurpose control and networking platform or to one or more user devices. In some embodiments, the broadcast controller may be embedded within the multipurpose control and networking platform.

A secondary node may refer to node controlled via a server of a connected primary node. Secondary nodes may be installed with at least one network switch (e.g., for connecting to one or more networked devices) and a gateway (e.g., for signal conversion) but without a server. Secondary nodes may thus connect networked devices to the multipurpose control and networking platform or to the broadcast controller via primary nodes.

In some embodiments, the at least one secondary node may be configured for connecting at least a first device of the plurality of networked devices to the at least one primary node. The system may also include at least one processor. The at least one processor may be configured to connect, using the at least one primary node and the at least one secondary node, at least the first device for secure communications with the broadcast controller. The connection between the first device and the broadcast controller may include at least one primary node and at least one secondary node. In some embodiments, the at least one primary node and at least one secondary node may enable an event network. The at least one processor may be configured to manage the secure communications with the broadcast controller (e.g., the secure communications between the broadcast controller and the plurality of networked devices). Managing may refer to overseeing or controlling the various elements or aspects of a secure communication system or network to ensure that information is transmitted and received in a secure and protected manner. Managing may also refer to dynamically adapting (as described and exemplified elsewhere herein).

The at least one processor may further be configured to assign, when the connection between at least the first device and the broadcast controller meets a predetermined assignment threshold, an assignment indicator to the connection. Examples of the assignment indicator may include active, inactive, quarantined, authenticated, new, expired, reported, and unreported. An example of assigning the assignment indicator may include when the system evaluates the device type and its capabilities or when the system poles for devices and receives a response, and further wherein the system recognizes that the device (i) is prepared to enter relevant operating modes based on a determination that certain parameters of the device meet or exceed one or more threshold values required for operation, or (ii) is available to the system to be deployed into use for an allocated service function, feature, or other capability based on, e.g., a determination that authentication data provided by the device or a user thereof matches one or more values known to the at least one processor. Examples of the predetermined assignment threshold may include threshold or data values which, when matched or exceeded, indicate that the connection is enabled, established, stable, healthy, or otherwise sufficiently or fully connected, or that the user or device matches a user or device identifier. Other examples of the predetermined assignment threshold may include threshold or data values which, when matched or exceeded, indicate that the user or device is identified by the network of the system, or that the device is connected and aware of the system, or that the system is aware of the device and the device's state of capability. Still further examples of the assignment threshold or data value may be thresholds of values associated with network health, connection stability, an acceptable packet loss value, full connectivity, authentication or authorization data, or device identifier data. In some embodiments, the at least one processor may be further configured to securely connect at least a first device of the plurality of networked devices to the broadcast controller based on the assignment indicator. In some embodiments, the at least one primary node, the at least one secondary node, at least the first device, and the assignment indicator enable a secure production network. In some embodiments, the at least one primary node and the at least one secondary node may capture signals between at least the first device and the broadcast controller. In some embodiments, the first device may be arranged at a first location. In some embodiments, the at least one secondary node may be arranged also at the first location, while the at least one primary node may be arranged either at the first location or at a location remote from the first location. In some embodiments, the at least one processor may be configured to deploy at least one additional secondary node at a second location remote from the first location, wherein the at least one additional secondary node is configured for connecting at least a second device of the plurality of networked devices to the broadcast controller using the at least one primary node, wherein the second device is arranged at the second location. In some embodiments, the at least one of the primary node, the secondary node, and the additional secondary node may be connected within the main location or across locations via at least one of wired or wireless communication technology. In some embodiments, the at least one processor may be configured to scale the system either up or down by connecting or disconnecting one or more of the plurality of networked devices. In some embodiments, the at least one processor may be configured to scale the system either up or down by connecting or disconnecting one or more of resources, routing paths, services, functions, or scopes of services. In some embodiments, the at least one secondary node may connect to a server of the at least one primary node. Further, the at least one processor may be configured to control the at least one secondary node via the server. In some embodiments, the system may include a throwdown node. A throwdown node may refer to a node smaller than secondary nodes (e.g., a node comprising a gateway but not a network switch or a server) and connected to a secondary node. A throwdown node may be utilized in locations where networked devices are installed but space is limited or the need for continued or prolonged transmission of signals is low. In some embodiments, the throwdown node may operate in the absence of an internal server or switch, and thus the throwdown node may be smaller in size than primary or secondary nodes. The throwdown node may be connected to a switch of the at least one secondary node to which it is connected. In some embodiments, the at least one processor may be configured to control the throwdown node, and thereby a connected networked device, via at least one of the switch of the at least one secondary node or the server of the primary node to which the secondary node is connected.

In some embodiments, the at least one processor may further be configured to provide a user interface including controls and a displayed visualization including at least the first device in secure communications with the broadcast controller. The at least one processor may be further configured to receive a user input for at least one of the controls via the user interface, and modify the management of the secure communications based on the user input. In some embodiments, modifying the management of the secure communications may include converting the at least one secondary node into a second primary node and deploying a server for the second primary node. Once a server is deployed for the secondary node, the secondary node may function as a primary node, as it gains its own server and no longer relies on the server of a connected primary node for control or for connecting to the multipurpose control and networking platform or to the broadcast controller. The converted secondary node (or second primary node) may thus function as a second master node. This functionality enables the mixed master/multi-master configuration, which is particularly beneficial in larger scale production environments that span multiple locations (e.g., multiple venues) or a large single location (e.g., a large venue with a plurality of connected devices or stages). Modifying the management of the secure communications may also include converting at least one throwdown node into a secondary node (e.g., by deploying a switch for the throwdown node), converting a primary node into a secondary node or a throwdown node (e.g., by removing a server and/or switch associated with the primary node), deploying additional nodes, or removing, rearranging, or isolating existing nodes.

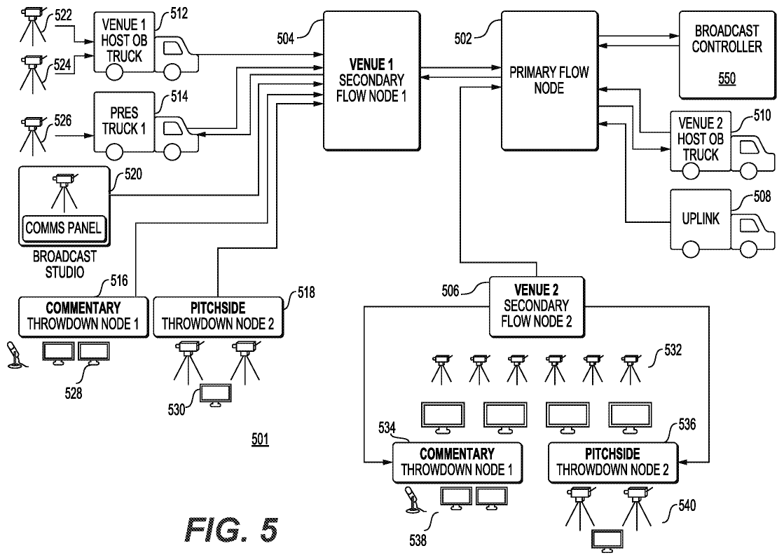

FIG. 5 shows a diagram of an example production environment including a computer-implemented system 501 for an event spanning multiple venues. System 501 may include a primary node 502 connected to secondary nodes 504, 506. Primary node 502 may further be connected to technical hubs 508, 510 (e.g., production trucks or mobile units) and to broadcast controller 550. Secondary nodes 504, 506 may correspond to different venues, wherein the different venues relate to the same sporting event. Secondary node 504 may further be connected to technical hubs 512, 514 located at the first venue, a broadcast studio 520 located at the first venue, and a plurality of networked devices 522, 524, 526 located at the first venue. Secondary node 504 may also be connected to further networked devices 528, 530 located at the first venue via throwdown nodes 516, 518. Secondary node 506 may further be connected to another plurality of networked devices 532 located at the second venue. Secondary node 506 may also be connected to additional networked devices 538, 540 located at the second venue via throwdown nodes 534, 536.

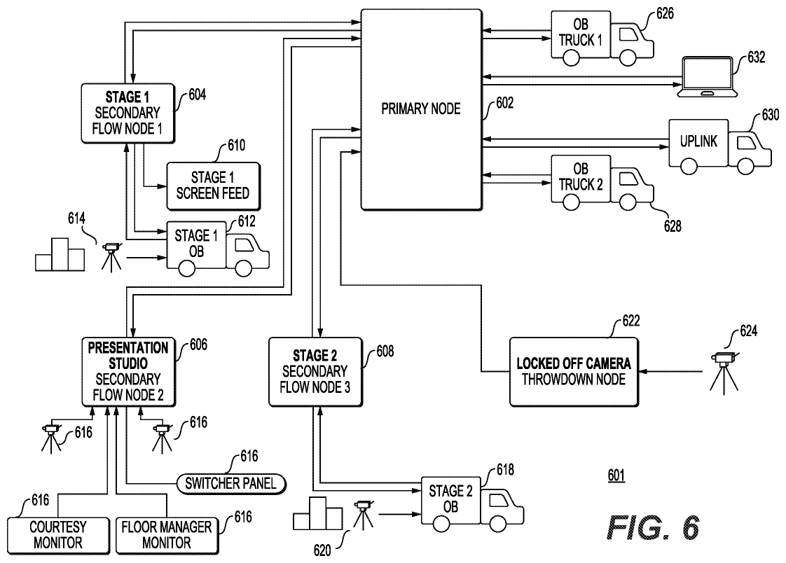

FIG. 6 shows a diagram of another example production environment including a computer-implemented system 601 for a large scale broadcasting event (e.g., a music festival with multiple stages at a large location). System 601 may include primary node 602 connected to secondary nodes 604, 606, 608. Primary node 602 may further be connected to technical hubs 626, 628, 630 and to broadcast controller 632. Secondary nodes 604, 606, 608 may correspond to different stages, wherein the different stages relate to the same event. Secondary node 604 may further be connected to technical hubs 610, 612 associated with the first stage, and to networked device 614 associated with technical hub 612. Secondary node 606 may further be connected to a presentation studio and networked devices 616 located within or associated with the presentation studio. Secondary node 608 may further be connected to technical hub 618, and to networked device 620 associated with technical hub 618. Primary node 602 may further be connected to additional networked device 624 via throwdown node 622.

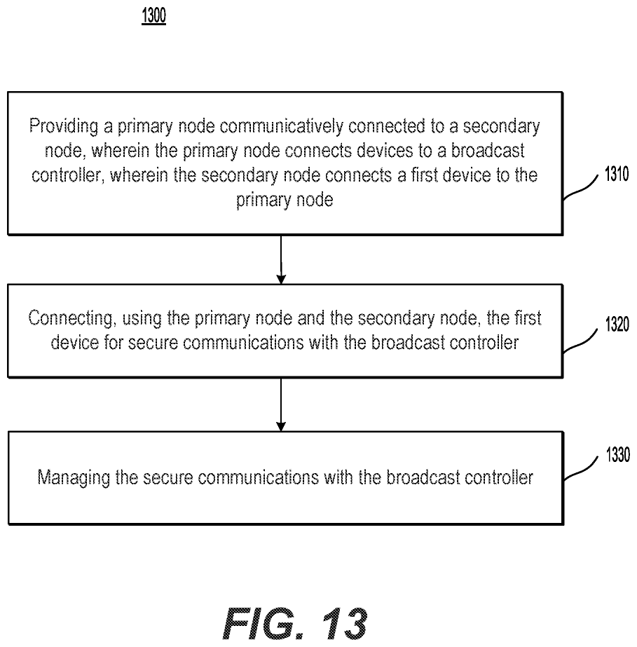

According to another embodiment of the present disclosure, a method for dynamically connecting a plurality of network devices for secure communications is provided. The steps embodied in the method may be performed by at least one processor of system 101 of FIG. 1 or system 201 of FIG. 2, as described herein. Referring to FIG. 13, a flowchart is illustrated for an example method for dynamically connecting a plurality of network devices for secure communications. As shown in FIG. 13, the method may start at step 1310 which includes providing at least one primary node communicatively connected to at least one secondary node, wherein the at least one primary node is configured for connecting the plurality of networked devices to a broadcast controller, the broadcast controller transmitting at least one of audio signals, video signals, or data signals captured by the plurality of networked devices to multiple recipient devices, wherein the at least one secondary node is configured for connecting at least a first device of the plurality of networked devices to the at least one primary node. At step 1320, method 1300 may include connecting, using the at least one primary node and the at least one secondary node, at least the first device for secure communications with the broadcast controller. At step 1330, method 1300 may include managing the secure communications with the broadcast controller.

According to yet another embodiment of the present disclosure, a non-transitory computer readable medium is provided, the non-transitory computer readable medium containing instructions that when executed by at least one processor cause the at least one processor to perform operations for dynamically connecting a plurality of network devices for secure communications. The steps embodied in the instructions of the non-transitory computer readable medium may be performed by at least one processor of system 101 of FIG. 1 or system 201 of FIG. 2, as described herein. These steps may be similar to those described above with reference to the example method of FIG. 13. As such, the steps may be configured for providing at least one primary node communicatively connected to at least one secondary node, wherein the at least one primary node is configured for connecting the plurality of networked devices to a broadcast controller, the broadcast controller transmitting at least one of audio signals, video signals, or data signals captured by the plurality of networked devices to multiple recipient devices, wherein the at least one secondary node is configured for connecting at least a first device of the plurality of networked devices to the at least one primary node. The steps may further be configured for connecting, using the at least one primary node and the at least one secondary node, at least the first device for secure communications with the broadcast controller. The steps may also be configured for managing the secure communications with the broadcast controller.

Embodiments of the present disclosure also include computer-implemented systems and methods for providing software-defined networking solutions or a software-defined network. A software-defined network generally refers to an architecture that separates a network's control plane functions from its data plane functions. This may be achieved by shifting the control and management of networked devices and services or features from individual, distributed hardware devices to a centralized, software-based system. In some embodiments, a system is provided that includes a plurality of devices (e.g., networked devices comprising broadcasting devices and networking devices). The system may further include a broadcast controller (as previously described and exemplified). The system may also include at least one processor. The at least one processor may be integrated or linked with the broadcast controller, wherein the at least one processor is configured to deliver media flow-aware and data flow-aware orchestration of endpoint devices or resources, supervision and optimization of workflows, and continuous monitoring. For example, the at least one processor may be configured to provide over-the-top management of network switches, wherein the management is agnostic with respect to any vendor-specific requirements associated with the network switches. The at least one processor may also be configured to connect, via a new connection, at least one of the plurality of devices to the broadcast controller regardless of the type of broadcast controller or the type of device. Such examples of technological agnosticism may be achieved, e.g., by implementing one or more APIs which carry various well-known drivers for broadcast controllers, network switches, or devices, wherein the drivers are installed via the one or more APIs, on an as-needed basis, on particular software or hardware components associated with a production environment. The at least one processor may configure or connect networked devices by spinning up (or down) containers or clusters which run microservices (e.g., independently developed services where each service maintains a specific process to fulfill a specific requirement). The at least one processor may further orchestrate the configurations or connections associated with the networked devices (e.g., by responding to detected changes in the production network), ensure high availability of devices and resources (e.g., by providing redundant container instances), and ensure scalable performance (e.g., by spinning up or down container instances based on, e.g., load, workflow interruptions, or detected failures).

The at least one processor may further be configured to scan the new connection to detect a newly connected device or a user of the connected device. In some embodiments, when the new connection is scanned, the at least one processor may be configured to assign the detected device or the user. The at least one processor may also be configured to remove the connected device or the user of the connected device from the network. The at least one processor may further be configured to monitor the connected device or the user of the connected device. Such monitoring may be performed by a monitoring component of the software-defined network. A monitoring component may include a set of monitoring devices which may continuously gather data (e.g., logs, metrics, or configuration parameters associated with networked devices or other resources of a production network). The set of monitoring devices may gather data to determine, e.g., overall network integrity, optical hardware metrics, device hardware health, connection network health, overlay states, burst detection, bandwidth consumption, rule matching, aggregate logs, errors, anomalies, or abnormalities. The monitoring component may provide both streaming telemetry (e.g., gRPC, Web Sockets, raw listeners) and polling approaches (e.g., SNMP, HTTP endpoints). In some embodiments, the monitoring component may favor streaming telemetry over polling approaches, as telemetry data may enable increase resolution, incremental updates for greater efficiency and accuracy, faster decision making or automation, and less overhead cost based on lighter monitoring devices. The set of monitoring devices may also feed data into a time-series database to facilitate the aggregation of data. To further improve indexing and aggregation of the collected data, log information across devices may be normalized to be interoperable by, e.g., the software-defined network, the at least one processor, the broadcast controller, or the multipurpose control and networking platform. The monitoring component may further be scalable for collecting, processing, and storing the collected data from a plurality of devices or resources. By deploying the monitoring devices or the monitoring component as one or more containers running in a cluster, the one or more containers enable scaling by encompassing microservices which may be spun up or down based on a given production network having particular types of devices or needing particular resources. The monitoring component thereby allows for scaling of the monitoring devices as appropriate, leading to reliable and high performance monitoring of the network regardless of the size of a production network, and even at the largest of events or production networks. The monitoring component may thus collect a large amount of data which may be further fed to a machine learning model which may perform supervised or unsupervised learning or statistical modeling based on the data. Both the collected data and the machine learning model output may be valuable data which may further be utilized for future designs or architectures of production networks. In addition, the monitoring component may be linked or integrated with the broadcast controller in order to understand the production network that is being monitored and learn what metrics or parameters are considered normal for that production network. Because the broadcast controller is aware of various production templates and the production template currently in use, the monitoring component may modify certain monitoring parameters (e.g., thresholds which may lead to a determination of an alert) based on information available to the broadcast controller. Based on the modifying, the monitoring component may be enabled to detect anomalies, errors, or abnormalities for the specific production network being implemented by the broadcast controller.

The at least one processor may further be configured to dynamically adapt at least one of a service solution or a feature running on the plurality of networked devices in response to (i) the detected newly connected device or user thereof (ii) the removed newly connected device or user thereof, (iii) the monitoring of the connected device or user thereof, or (iv) a schedule, calendar, or sequence of events. Dynamically adapting may refer to adjusting, modifying, or changing the behavior, characteristics, or parameters of networked devices or other resources in real-time or automatically as conditions change. Dynamic adaptation may allow the components of a production environment to respond to varying circumstances, requirements, or inputs to optimize performance, efficiency, responsiveness, resiliency, or other functionalities of connected devices or resources. For example, when a newly connected device is detected and assigned by the at least one processor, dynamically adapting may include configuring and deploying a service or feature to the newly connected and assigned device. Furthermore, the configuration and deployment may require additional resources to be routed to the newly connected device, and the at least one processor may identify and connect those additional resources to the newly connected device. As another example, a newly connected and assigned device may replace or supplement another connected device, and the at least one processor may redefine routing paths between resources and each connected device based on the replacement or supplementation. As yet another example, a removed device or lost or failing resource may be detected in which case a replacement connected device or resource may be identified and routed to the multipurpose control and networking platform or to the broadcast controller by the at least one processor. As a result of the dynamic adaptation continuously (or at least periodically) performed by the at least one processor, user-desired services and features may run continuously and seamlessly across the plurality of networked devices, the broadcast controller, and other resources of the system as different devices connect to or disconnect from a production environment.

In some embodiments, dynamically adapting the at least one of the service solution or feature may include, e.g., configuring, using a template file or machine image, the detected connected device for running the at least one of the service solution or feature. Such configuration may be performed by a configurator component of the software-defined network. A configurator component may include one or more clusters or containers running configuration services or microservices for configuring and provisioning the fabric (e.g., devices, resources, or platforms, and the workflows therebetween) of a production network. The configurator component may enable all network device configurations to be automated based on a database or repository of proven configuration templates without requiring any human intervention or manual configuration (e.g., by a network engineer) during the automated process. The configuration services or microservices may enable users to apply a configuration baseline or to rollback configurations for one or more connected devices. The configuration services or microservices may include discovering or mapping a production network topology, discovering or reporting hosts on the production network, assigning devices on the network by configuring network switches and managing IP addresses of connected devices, automating baseline configurations by establishing core routing paths, enabling provision of data services, or enforcing authenticated access by devices or users thereof.

In some embodiments, dynamically adapting the at least one of the service solution or feature may include, e.g., re-routing a connection to the detected connected device over a network without disrupting the at least one of the service solution or feature. Such re-routing may be performed by a pathfinder component of the software-defined network. A pathfinder component may include services or microservices running on one or more clusters or containers that identify and program real-time multicast routes into a production network topology for both media flows and data service flows, apply policing based on the format of a corresponding broadcasting or networking device, and perform load balancing (e.g., to prevent oversubscription to devices or resources, or to prevent workflow congestion) based on network logic which may include media flow or data service flow priorities. In some embodiments, the network logic may be captured based at least in part on the integrated or linked broadcast controller. As a result of such integration or linking, the pathfinder component may be enabled to detect and identify all network devices, resources, ports, media workflows, data service workflows, and bandwidths associated with a production network. In some embodiments, re-routing the connection may include, e.g., automatically remapping one or more paths on the network based on a newly connected, disconnected, or failing component of the network using, e.g., a graph database. The pathfinder component may be configured to detect routing paths by using cyphers with custom algorithms based on, e.g., shortest path (or least hops), bandwidth (e.g., in one or more of a load balanced, optimized, prioritized, or distributed mode), protected or virtually isolated groups of devices or resources, reservations of devices or resources, or availability or overhead space. In some embodiments, automatically remapping the network may include, e.g., determining a priority associated with the at least one of the service solution or feature and modifying the one or more paths on the network based on the determined priority or based on real-time circumstances of the production network. In some embodiments, dynamically adapting the at least one of the service solution or feature may include defining a first route between the detected connected device and the broadcast controller and a second route between the detected connected device and the broadcast controller, wherein the second route is configured to replace the first route upon a detection of a disconnected or failing component of the first route. In some embodiments, dynamically adapting the at least one of the service solution or feature may include, e.g., scheduling the at least one of the service solution or feature based on broadcast control commands made to or from the broadcast controller. Such scheduling may be performed by a scheduling component of the software-defined network, wherein the scheduling component is integrated or linked with the broadcast controller such that the software-defined network (or at least one processor) has full visibility of media and data flows and switches throughout the production network based on the link or integration with the broadcast controller and thereby the information known to the broadcast controller. A scheduling component may include one or more services or microservices running on one or more clusters or containers which automate routing and service provisioning based on a calendar, sequences of events associated with a production, or broadcast control commands. Broadcast control commands may refer to specific instructions or commands issued by a user or control center (e.g., broadcast controller) to modify or manipulate the transmission of audio, video, or data content in a broadcasting network. Broadcast control commands may include input data related to content scheduling, signal routing, playout management, data transmission control, and other operational tasks associated with a broadcast production or event network.

In some embodiments, the at least one processor may be configured to dynamically adapt resources for providing the at least one of the service solution or feature, wherein the resources are accessible via a centralized resource pool. In some embodiments, the at least one processor may be further configured to place the detected connected device into the centralized resource pool and make the detected device available as a resource on demand or when called for by an event request based on a desired application of that device. In some embodiments, the at least one processor may be further configured to determine if the connected device or the user of the connected device was previously reported. Reporting may refer to identifying a device or user as an authorized or authenticated device or user, wherein it would be secure to assign the identified device or user. Reporting may also refer to identifying or determining that a device or user is no longer authorized or authenticated (e.g., a device which should no longer exist according to a production schedule, or a device that has been identified as not secure (or no longer secure), e.g., based on a detected security incident associated with the device or user). When the connected device or the user of the connected device has not been previously authorized, or when the connected device or the user of the connected device has been determined as no longer authorized or authenticated, the at least one processor may be configured to quarantine the connected device or the user of the connected device. When the device or the user has been previously authorized, the at least one processor may be configured to keep the device or the user in an active queue. An active queue may refer to a data structure used to store or prioritize a list of authorized and authenticated networked devices or users of one or more production environments. The active queue may enable the at least one processor to maintain and process items or tasks for each listed networked device in an order or based on other specified rules or criteria. In some embodiments, the at least one processor may be configured to manage the active queue, wherein managing the active queue is based on resource allocation information (e.g., a resource allocation definition) associated with each device in the active queue. In some embodiments, the at least one processor may be configured to provide, for the connected device or the user of the connected device, a tag based on the resource allocation information. A tag may refer to an electronic or digital label or marker associated with a networked device or other resource which may provide additional context, identification, or categorization for the networked device or other resource. Tags may be used, e.g., to organize, classify, search for, monitor, control, or dynamically adapt various networked devices and resources. In some embodiments, the tag may include information such as at least one of a configuration state, an address, a use definition, a configuration profile, a functionality preset, or an active role associated with a networked device or other resource. Tagging may be implemented, e.g., to provide end users with a meaningful and tangible signal (e.g., video, audio, ancillary/metadata) or signal type (e.g., source signal or target signal) associated with a device or resource. For example, one or multiple signals of a given production flow may be combined and exposed to the end user, via tagging, as targets or sources (e.g., tags such as “camera-1,” “production monitor-5,” or “replay input-7”). In dynamic production environments, various devices or resources may be combined or interchanged with other devices or resources; however, the tags associated with the various devices or resources may also be combined or interchanged accordingly. As a result, tagging may enable end users to understand signal flows in the broadcast environment based on abstracted data flows and regardless of which specific device or resource is utilized for a particular data flow on a given day or in a given production. Tagging may also enable the at least one processor to dynamically adapt the at least one service solution or feature. For example, tags associated with connected devices or workflows may quickly provide relevant information to the at least one processor, such as capabilities or capacities of each connected device or requirements or parameters of each workflow. As a result, the at least one processor may dynamically adapt the at least one service solution or feature by modifying or interchanging the connections between devices or the configurations of the connected devices. Furthermore, tagging may be implemented in a cascading fashion, wherein a change of a tag associated with an upstream device or resource in a particular data flow may be implemented automatically on all devices or resources downstream of the upstream device in the same data flow. As a result, a new or modified tag may be associated with all devices and resources that make up each data flow.

In some embodiments, the at least one processor may be embedded within the broadcast controller, or the software-defined network may be embedded within the broadcast controller. Embedding may refer to integrating one component (e.g., the at least one processor or the SDN) into another component (e.g., the broadcast controller). Embedding may enhance or extend the functionality or capabilities of the at least one processor. Embedding may further enable lean architecture, efficiency, a reduced footprint, and maximum the utilization of connected devices and resources.

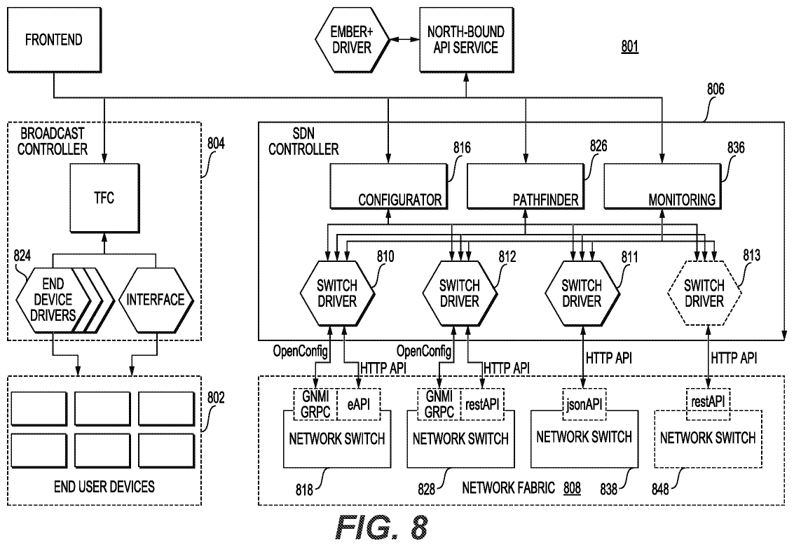

FIG. 8 shows a diagram of an example operating environment including a computer-implemented system 801 including end user devices 802, broadcast controller 804, and a software-defined network (SDN) including an SDN controller 806 and network switches 808. Broadcast controller 804 may connect to various end user devices 802 and may be compatible with various types of end user devices based on end device drivers 824 stored within broadcast controller 804. SDN controller 806 may be connected to broadcast controller 804, and SDN controller 806 may communicate with end user devices 802 via broadcast controller 804. SDN controller 806 may include configurator component 816, pathfinder component 826, and monitoring component 836. Components 816, 826, 836 may perform functions related to configuring, re-routing, and monitoring of end user devices 802 or network switches 808 (as described and exemplified above). Because components 816, 826, 836 are also connected with broadcast controller 804, SDN controller 806 or the software-defined network may perform such functions with an understanding of where signals from each broadcasting device are required to be transmitted. The integration of broadcast controller 804 with components 816, 826, 836 of SDN controller 806 thereby enables efficient and effective configuring, routing, monitoring, and controlling of various deployments based on actual connections and applications of the broadcasting devices. Components 816, 826, 836 may also function properly with a variety of network switch types 818, 828, 838, 848 by utilizing a variety of corresponding network switch drivers 810-813 stored on the software-defined network or integrated with SDN controller 806. Components 816, 826, 836 may also function properly with a variety of networked device types 802 by utilizing corresponding end device drivers 824 of broadcast controller 804 for compatibility with various end device types.

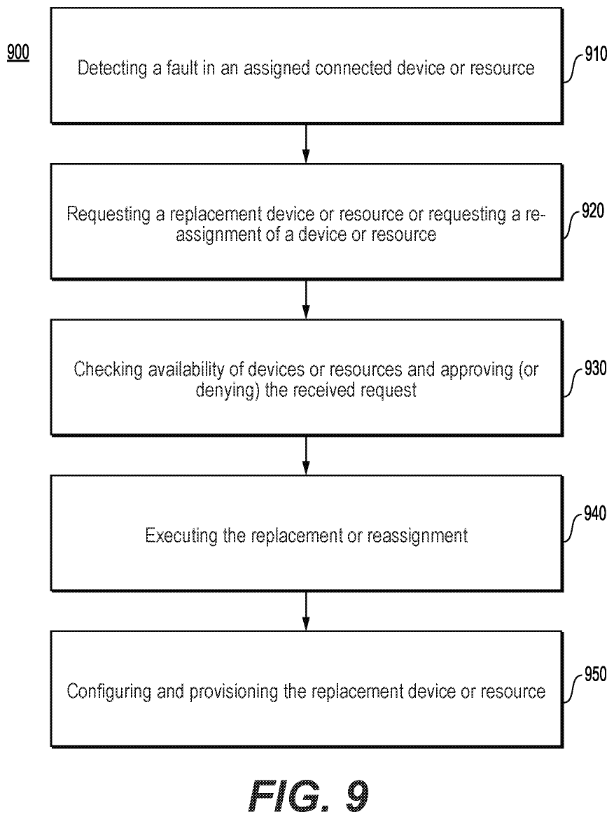

FIG. 9 shows a flowchart of an example process 900 for utilizing a centralized resource pool to recover from an equipment fault (e.g., re-routing). Process 900 may be performed, e.g., by at least one processor of Link 104 or multipurpose control and networking platform 102 of FIG. 1, or by at least one processor of multipurpose control and networking platform 300 of FIG. 2. Process 900 may include a step 910 of detecting a fault in an assigned connected device or resource. The fault may be detected by, e.g., the software-defined network, the multipurpose control and networking platform, or a user thereof. Process 900 may further include a step 920 of requesting a replacement device or resource or requesting a re-assignment of a device or resource. Requesting may be performed by, e.g., the software-defined network, the multipurpose control and networking platform, or a user thereof. Process 900 may also include a step 930 of checking availability of devices or resources and approving (or denying) the received request. Availability may be checked, and the request may be approved (or denied), by, e.g., a scheduling component of the software-defined network, by the multipurpose control and networking platform, or by a user thereof. Process 900 may further include a step 940 of executing the approved replacement or reassignment by re-routing signal slows, duplicating parameter values from the faulty device or resource to the replacement device or resource, and providing control of the replacement device or resource to a user. Process 900 may also include a step 950 of configuring and provisioning the replacement device or resource to complete the recovery process.

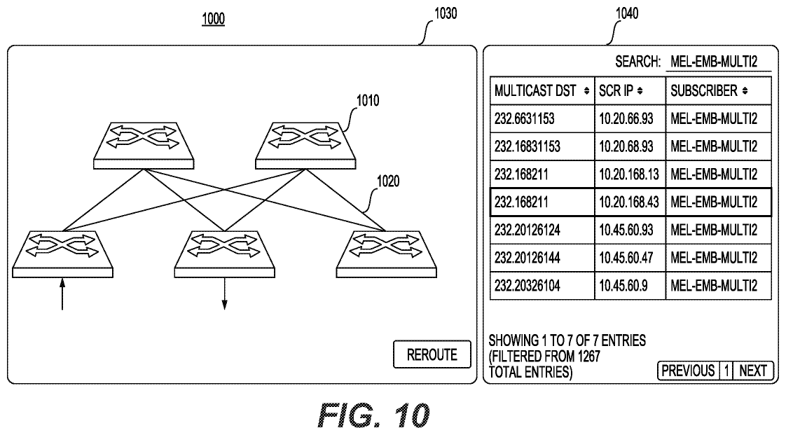

FIG. 10 shows a diagram of an example graphical user interface 1000 for providing a visualization and control tool for a software-defined network. Graphical user interface 1000 may be generated and implemented by and for use with the disclosed embodiments of the multipurpose control and network platform, e.g., via 102 of FIG. 1 or via 300 of FIG. 2. Further, graphical user interface 1000 may be made accessible to users through a combination of user interfaces and/or one or more networks, e.g., via Internet 100 of FIG. 1 and/or user interface 202 of FIG. 2. By way of example, graphical user interface 1000 may be accessed by one or more users, e.g., users 110, 120, 130, 140, 150, 160 of FIG. 2. Graphical user interface 1000 may be configured to enable users to search and view nodes in the network (a spine-leaf network is illustrated in the example of FIG. 10) and provide inputs to cause the dynamic adaption of service solutions or features of the network. The user inputs and dynamic adaptions may be provided to and implemented using at least one processor, e.g., at least one processor of 102, 104, or 106 of FIG. 1 or at least one processor of 300 of FIG. 2. As shown in FIG. 10, graphical user interface 1000 includes a visualization 1030 of network switches 1010 and the connections 1020 between them. The display of such a visualization 1030 may aid a user in understanding the redundant paths available within the production network, and/or confirm the state (e.g., health, connectivity, stability, etc.) of the connections within the network, as well as determine available replacement devices when necessary (e.g., upon the detection of an equipment fault). Graphical user interface 1000 may further display configuration data or other parameters 1040 associated with each visualized network switch or other node. In some embodiments, the configuration data or other parameters 1040 may be searched, filtered, and displayed based on user-desired preferences, and visualization 1030 may be automatically updated based on the filtered results.

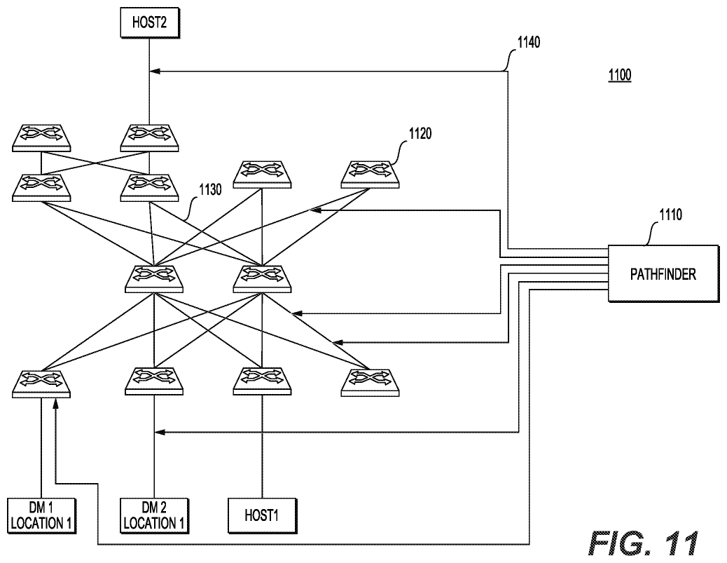

FIG. 11 shows a diagram of a system 1100 including a pathfinder component 1110 for a software-defined network with one or more nodes 1120 and connections 1130. Pathfinder component 1110 may be configured to gather real-time data and information 1140 from devices and connections of the software-defined network and assist with re-routing a connection without disrupting a provisioned service solution or feature. As disclosed with reference to FIG. 8, a pathfinder component may be implemented as part of a controller (e.g., 806) for the software-defined network. Other components (not shown in FIG. 11) may be provided with pathfinder component 1110, such as a configurator (e.g., 816) and monitoring component (e.g., 836), as shown in FIG. 8. In some embodiments, pathfinder component 1110 may include services or microservices running on one or more clusters or containers that identify and program real-time multicast routes into a production network topology, such as that shown in FIG. 11, for both media flows and data service flows, apply control policies based on the format of a corresponding broadcasting or networking device, and perform load balancing (e.g., to prevent oversubscription to devices or resources, or to prevent workflow congestion) based on network logic which may include media flow or data service flow priorities. In some embodiments, the network logic may be captured based at least in part on the integrated or linked broadcast controller. In some embodiments, re-routing the connection may include, e.g., automatically remapping one or more paths on the network based on a newly connected, disconnected, or failing component of the network (such as device 1120) using, e.g., a graph database (not shown). The pathfinder component may be configured to detect routing paths by using cyphers with custom algorithms based on, e.g., shortest path (or least hops), bandwidth (e.g., in one or more of a load balanced, optimized, prioritized, or distributed mode), protected or virtually isolated groups of devices or resources, reservations of devices or resources, or availability or overhead space. In some embodiments, automatically remapping the network may include, e.g., determining a priority associated with the at least one of the service solution or feature and modifying the one or more paths on the network based on the determined priority or based on real-time circumstances of the production network. In some embodiments, dynamically adapting the at least one of the service solution or feature may include defining a first route (e.g., including connection 1130) between the detected connected device and the broadcast controller and a second route (e.g., including other connections) between the detected connected device and the broadcast controller, wherein the second route is configured to replace the first route upon a detection of a disconnected or failing component of the first route. In some embodiments, dynamically adapting the at least one of the service solution or feature may include, e.g., scheduling the at least one of the service solution or feature based on broadcast control commands made to or from the broadcast controller. Such scheduling may be performed by a scheduling component (not shown in FIG. 11) of the software-defined network, wherein the scheduling component is integrated or linked with the broadcast controller such that the software-defined network (or at least one processor) has full visibility of media and data flows and switches throughout the production network based on the link or integration with the broadcast controller and thereby the information known to the broadcast controller. A scheduling component may include one or more services or microservices running on one or more clusters or containers which automate routing and service provisioning based on a calendar, sequences of events associated with a production, or broadcast control commands. Broadcast control commands may refer to specific instructions or commands issued by a user or control center (e.g., broadcast controller) to modify or manipulate the transmission of audio, video, or data content in a broadcasting network. Examples of broadcast control commands include commands related to content scheduling, signal routing, playout management, data transmission control, and other operational tasks associated with a broadcast production or event network.

In some embodiments, one or more graphical user interfaces may be generated and implemented to enable users to visualize the software-defined network and/or input broadcast control commands. As with the embodiment of FIG. 10, such graphical user interfaces may be made accessible to users through a combination of user interfaces and/or one or more networks, e.g., via Internet 100 of FIG. 1 and/or user interface 202 of FIG. 2. By way of example, graphical user interface 1100 may be accessed by one or more users, e.g., users 110, 120, 130, 140, 150, 160 of FIG. 2. Such graphical user interfaces may be configured to enable users to provide commands and other inputs to cause the dynamic adapting of service solutions or features provided via, e.g., at least one processor of 102, 104, or 106 of FIG. 1 or at least one processor of 300 of FIG. 2. In some embodiments, graphical user interfaces may be provided to enable real-time visualization of a deployed software-defined network, including the configuration, arrangement, and status of all network switches and connections, as well as path re-routing and other dynamic adaptions applied to the network.

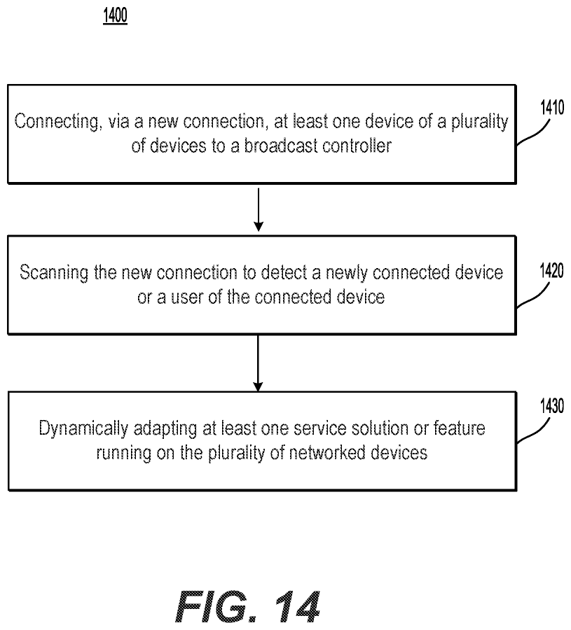

According to another embodiment of the present disclosure, a method for providing a software-defined network is provided. The steps embodied in the method may be performed by at least one processor of system 101 of FIG. 1 or system 201 of FIG. 2, as described herein. Referring to FIG. 14, a flowchart is illustrated for an example method for providing a software-defined network. As shown in FIG. 14, the method may start at step 1410, which includes connecting, via a new connection, at least one device of a plurality of devices to a broadcast controller. The broadcast controller may be configured to transmit at least one of audio signals, video signals, or data signals from the plurality of devices to multiple recipient devices. At step 1420, method 1400 may include scanning the new connection to detect a newly connected device or a user of the connected device. At step 1420, method 1400 may include dynamically adapting at least one of a service solution or a feature running on the plurality of networked devices in response to the detected newly connected device or user thereof.

According to yet another embodiment of the present disclosure, a non-transitory computer readable medium is provided, the non-transitory computer readable medium containing instructions that when executed by at least one processor cause the at least one processor to perform operations for providing a software-defined network. The steps embodied in the instructions of the non-transitory computer readable medium may be performed by at least one processor of system 101 of FIG. 1 or system 201 of FIG. 2, as described herein. These steps may be similar to those described above with reference to the example method of FIG. 14. As such, the steps may be configured for connecting, via a new connection, at least one device of a plurality of devices to a broadcast controller, the broadcast controller being configured to transmit at least one of audio signals, video signals, or data signals from the plurality of devices to multiple recipient devices. The steps may also be configured for scanning the new connection to detect a newly connected device or a user of the connected device. The steps may further be configured for dynamically adapting at least one of a service solution or a feature running on the plurality of networked devices in response to the detected newly connected device or user thereof.

The diagrams and components in the figures described above illustrate the architecture, functionality, and operation of possible implementations of systems, methods, and computer hardware or software products according to various example embodiments of the present disclosure. For example, each block in a flowchart or diagram may represent a module, segment, or portion of code, which includes one or more executable instructions for implementing the specified logical functions. It should also be understood that in some alternative implementations, functions indicated in a block may occur out of order noted in the figures. By way of example, two blocks or steps shown in succession may be executed or implemented substantially concurrently, or two blocks or steps may sometimes be executed in reverse order, depending upon the functionality involved. Furthermore, some blocks or steps may be omitted. It should also be understood that each block or step of the diagrams, and combination of the blocks or steps, may be implemented by special purpose hardware-based systems that perform the specified functions or acts, or by combinations of special purpose hardware and computer instructions. Computer program products (e.g., software or program instructions) may also be implemented based on the described embodiments and illustrated examples.

It should be appreciated that the above-described systems and methods may be varied in many ways and that different features may be combined in different ways. In particular, not all the features shown above in a particular embodiment or implementation are necessary in every embodiment or implementation. Further combinations of the above features and implementations are also considered to be within the scope of the herein disclosed embodiments or implementations.

While certain embodiments and features of implementations have been described and illustrated herein, modifications, substitutions, changes and equivalents will be apparent to those skilled in the art. It is, therefore, to be understood that the appended claims are intended to cover all such modifications and changes that fall within the scope of the disclosed embodiments and features of the illustrated implementations. It should also be understood that the herein described embodiments have been presented by way of example only, not limitation, and various changes in form and details may be made. Any portion of the systems and/or methods described herein may be implemented in any combination, except mutually exclusive combinations. By way of example, the implementations described herein can include various combinations and/or sub-combinations of the functions, components and/or features of the different embodiments described.

Moreover, while illustrative embodiments have been described herein, the scope of the present disclosure includes embodiments having equivalent elements, modifications, omissions, combinations (e.g., of aspects across various embodiments), adaptations or alterations based on the embodiments disclosed herein. Further, elements in the claims are to be interpreted broadly based on the language employed in the claims and not limited to examples described herein or during the prosecution of the present application. Instead, these examples are to be construed as non-exclusive. It is intended, therefore, that the specification and examples herein be considered as exemplary only, with a true scope and spirit being indicated by the following claims and their full scope of equivalents.

What is claimed is:

1. A computer-implemented system for a multipurpose control and networking platform, the system comprising:
a plurality of networked devices comprising broadcasting devices, the broadcasting devices transmitting at least one of audio signals, video signals, or data signals, the plurality of networked devices being dynamically connected for secure communications with at least one processor;
the at least one processor being configured to:
configure at least one of a service solution or a feature;
deploy, among the plurality of networked devices, at least one of the service solution or the feature using one or more standalone local clusters for the plurality of networked devices; and
monitor and control the deployment of the at least one of the service solution or the feature.

2. The system of claim 1, wherein the deployment by the at least one processor among the plurality of networked devices or the monitoring and controlling of the deployment is technologically agnostic as to the type or capabilities of each networked device.

3. The system of claim 1, wherein the service solution comprises at least one of a software-enabled networking solution, a centralized production, a cloud production, and a live production.

4. The system of claim 1, wherein the feature comprises at least one of a device configuration, a device control, an IP routing, system and network monitoring, a rules-based audio and video alignment, a resource schedule, resource share, network and device security, scaling, workflow automation, user management, cloud production functionality, a device utilization scheme, an audio streaming system, a video streaming system, a media synchronization system, a metadata collection system, an asset tagging system, a media distribution system, and a metadata distribution system.

5. The system of claim 1, wherein the at least one processor is further configured to provide configuration data and control data over at least one application programming interface (API).

6. The system of claim 1, wherein monitoring and controlling the deployment includes assigning endpoints from a resource pool based on one or more productions and segregating the endpoints based on the one or more productions.

7. The system of claim 6, wherein the one or more productions are live productions.

8. The system of claim 6, the at least one processor being further configured to automate, based on a schedule, routing paths of the at least one of the service solution or the feature between the plurality of networked devices and the endpoints from the resource pool.

9. The system of claim 1, wherein the one or more standalone local clusters are configured to operate in an absence of connectivity to a cloud-based component.

10. The system of claim 1, wherein the at least one processor is further configured to generate a visualization via a user interface, the visualization indicating statuses or parameters associated with the plurality of networked devices.

11. The system of claim 1, wherein the broadcasting devices and networking devices are a combination of on-site devices and remote devices.

12. The system of claim 1, wherein monitoring and controlling the deployment comprises receiving data from a cloud-based cluster and transmitting the received data to the one or more standalone local clusters.

13. The system of claim 1, wherein monitoring and controlling the deployment comprises receiving data from the one or more standalone clusters and transmitting the received data to a cloud-based cluster.

14. The system of claim 1, wherein the at least one processor is further configured to enable a decentralized control of the deployments using a software-based user interface.

15. The system of claim 1, wherein controlling comprises scaling containers within the one or more standalone local clusters based on detected changes associated with the plurality of networked devices or the at least one of the service solution or the feature.

16. The system of claim 1, wherein the one or more standalone local clusters enable at least one of starting, pausing, restarting, or shutting down the at least part of the one of the service solution or the feature without disrupting the configuration of the at least one of the service solution or the feature.

17. The system of claim 1, wherein the plurality of networked devices further includes one or more networking devices for connecting the broadcasting devices to a broadcast controller.

18. The system of claim 17, wherein the broadcast controller further connects the broadcasting device to multiple recipient devices simultaneously.

19. A method for implementing a multipurpose control and networking platform, the method comprising the following steps performed by at least one processor:
dynamically connecting, for secure communications, a plurality of networked devices comprising broadcasting devices, the broadcasting devices transmitting at least one of audio signals, video signals, or data signals;
configuring at least one of a service solution or a feature;
deploying, among the plurality of networked devices, at least one of the service solution or the feature using one or more standalone local clusters for the plurality of networked devices; and
monitoring and controlling the deployment of the at least one of the service solution or the feature.

20. A non-transitory computer readable medium containing instructions that when executed by at least one processor cause the at least one processor to perform operations for implementing a multipurpose control and networking platform, the operations comprising:
dynamically connecting, for secure communications, a plurality of networked devices comprising broadcasting devices, the broadcasting devices transmitting at least one of audio signals, video signals, or data signals;
configuring at least one of a service solution or a feature;
deploying, among the plurality of networked devices, at least one of the service solution or the feature using one or more standalone local clusters for the plurality of networked devices; and
monitoring and controlling the deployment of the at least one of the service solution or the feature.

21. A system for dynamically connecting a plurality of networked devices for secure communications, the system comprising:
at least one primary node communicatively connected to at least one secondary node;
wherein the at least one primary node is configured for connecting the plurality of networked devices to a broadcast controller, the broadcast controller transmitting at least one of audio signals, video signals, or data signals captured by the plurality of networked devices to multiple recipient devices;
wherein the at least one secondary node is configured for connecting at least a first device of the plurality of networked devices to the at least one primary node; and
at least one processor configured to:
connect, using the at least one primary node and the at least one secondary node, at least the first device for secure communications with the broadcast controller; and
manage the secure communications with the broadcast controller.

22. The system of claim 21, wherein the at least one processor is further configured to assign, when the connection between at least the first device and the broadcast controller meets a predetermined assignment threshold, an assignment indicator to the connection.

23. The system of claim 22, wherein the at least one processor is further configured to securely connect at least the first device to the broadcast controller based on the assignment indicator.

24. The system of claim 22, wherein the at least one primary node, the at least one secondary node, at least the first device, and the assignment indicator enable a secure production network.

25. The system of claim 21, wherein the at least one primary node and the at least one secondary node capture signals between at least the first device and the broadcast controller, wherein the first device is arranged at a first location.

26. The system of claim 25, wherein the at least one processor is further configured to deploy at least one additional secondary node at a second location remote from the first location, wherein the at least one additional secondary node is configured for connecting at least a second device of the plurality of networked devices to the broadcast controller using the at least one primary node, wherein the second device is arranged at the second location.

27. The system of claim 21, wherein the at least one processor is further configured to scale the system up or down by connecting or disconnecting one or more of the plurality of networked devices.

28. The system of claim 21, wherein the at least one processor is further configured to scale the system up or down by connecting or disconnecting one or more of containers, resources, routes, services, or functions.

29. The system of claim 21, wherein the at least one secondary node connects to a server of the at least one primary node and wherein the at least one processor is configured to control the at least one secondary node via the server.

30. The system of claim 21, further comprising a throwdown node connected to the at least one secondary node or the at least one primary node, the throwdown node being:
controlled via a switch of the at least one secondary node or the at least one primary node; and
connected to at least a second device of the plurality of devices.

31. The system of claim 30, wherein the at least one processor is configured to control the throwdown node via the switch and a server of the primary node.

32. The system of claim 21, wherein the at least one processor is further configured to:
provide a user interface including controls and a displayed visualization including at least the first device in secure communications with the broadcast controller;
receive a user input for at least one of the controls via the user interface; and
modify the management of the secure communications based on the user input.

33. The system of claim 32, wherein modifying the management of the secure communications includes converting the at least one secondary node into a second primary node and deploying a server for the second primary node.

34. A method for dynamically connecting a plurality of networked devices for secure communications, the method comprising the following steps performed by at least one processor:
providing at least one primary node communicatively connected to at least one secondary node, wherein the at least one primary node is configured for connecting the plurality of networked devices to a broadcast controller, the broadcast controller transmitting at least one of audio signals, video signals, or data signals captured by the plurality of networked devices to multiple recipient devices, wherein the at least one secondary node is configured for connecting at least a first device of the plurality of networked devices to the at least one primary node;
connecting, using the at least one primary node and the at least one secondary node, at least the first device for secure communications with the broadcast controller; and
managing the secure communications with the broadcast controller.

35. A non-transitory computer readable medium containing instructions that when executed by at least one processor cause the at least one processor to perform operations for dynamically connecting a plurality of network devices for secure communications, the operations comprising:
providing at least one primary node communicatively connected to at least one secondary node, wherein the at least one primary node is configured for connecting the plurality of networked devices to a broadcast controller, the broadcast controller transmitting at least one of audio signals, video signals, or data signals captured by the plurality of networked devices to multiple recipient devices, wherein the at least one secondary node is configured for connecting at least a first device of the plurality of networked devices to the at least one primary node;
connecting, using the at least one primary node and the at least one secondary node, at least the first device for secure communications with the broadcast controller; and
managing the secure communications with the broadcast controller.

36. A system for providing a software-defined network for broadcasting, the system comprising:
a plurality of devices;
a broadcast controller configured to transmit at least one of audio signals, video signals, or data signals from the plurality of devices to multiple recipient devices; and
at least one processor configured to:
connect, via a new connection, at least one of the plurality of devices to the broadcast controller;
scan the new connection to detect a newly connected device or a user of the connected device; and
dynamically adapt at least one of a service solution or a feature running on the plurality of networked devices in response to the detected newly connected device or user thereof.

37. The system of claim 36, wherein the at least one processor is further configured to:
remove the connected device or the user of the connected device from the network based on at least one of a user input or a detected failure of the connected device or user thereof; and
dynamically adapt the at least one of the service solution or the feature in response to the removed connected device or user thereof.

38. The system of claim 36, wherein the at least one processor is further configured to dynamically adapt resources for providing the at least one of the service solution or the feature, wherein the resources are accessible via a centralized resource pool.

39. The system of claim 38, wherein when the new connection is scanned, the at least one processor is further configured to place the detected connected device into the centralized resource pool and make the detected device available on demand or when called for by an event request.

40. The system of claim 36, wherein the at least one processor is further configured to:
determine if the connected device or the user of the connected device was previously authorized;
if the connected device or the user of the connected device has not been previously authorized, quarantine the connected device or the user of the connected device; and
if the connected device or the user of the connected device has been previously authorized, keeping the connected device or the user of the connected device in an active queue.

41. The system of claim 40, wherein the at least one processor is further configured to regulate the active queue, wherein regulating the active queue is based on resource allocation information associated with each device in the active queue.

42. The system of claim 41, wherein the at least one processor is further configured to provide, for the connected device or the user of the connected device, a tag based on the resource allocation information.

43. The system of claim 42, wherein the tag is at least one of a configuration state, an address, a use definition, a configuration profile, a functionality preset, or an active role.

44. The system of claim 42, wherein dynamically adapting the at least one of the service solution or the feature is based on the tag or resource allocation information.

45. The system of claim 36, wherein dynamically adapting the at least one of the service solution or the feature includes configuring, using a template file, the detected connected device for running the at least one of the service solution or the feature.

46. The system of claim 36, wherein dynamically adapting the at least one of the service solution or the feature includes re-routing a connection to the detected connected device over a network without disrupting the at least one of the service solution or the feature.

47. The system of claim 46, wherein re-routing the connection includes automatically remapping one or more paths on the network based on a disconnected or failing component of the network.

48. The system of claim 47, wherein automatically remapping the network includes determining a priority associated with the at least one of the service solution or the feature and modifying the one or more paths on the network based on the determined priority.

49. The system of claim 36, wherein dynamically adapting the at least one of the service solution or the feature includes defining a first route between the detected connected device and the broadcast controller and a second route between the detected connected device and the broadcast controller, wherein the second route is configured to replace the first route upon a detection of a disconnected or failing component of the first route.

50. The system of claim 36, wherein dynamically adapting the at least one of the service solution or the feature includes scheduling the at least one of the service solution or the feature based on broadcast control commands made to the broadcast controller.

51. The system of claim 36, wherein the at least one processor is embedded within the broadcast controller.

52. A method for providing a software-defined network, the method comprising:
connecting, via a new connection, at least one device of a plurality of devices to a broadcast controller, the broadcast controller being configured to transmit at least one of audio signals, video signals, or data signals from the plurality of devices to multiple recipient devices;
scanning the new connection to detect a newly connected device or a user of the connected device; and
dynamically adapting at least one of a service solution or a feature running on the plurality of networked devices in response to the detected newly connected device or user thereof.

53. A non-transitory computer readable medium containing instructions that when executed by at least one processor cause the at least one processor to perform operations for providing a software-defined network, the operations comprising:
connecting, via a new connection, at least one device of a plurality of devices to a broadcast controller, the broadcast controller being configured to transmit at least one of audio signals, video signals, or data signals from the plurality of devices to multiple recipient devices;
scanning the new connection to detect a newly connected device or a user of the connected device; and
dynamically adapting at least one of a service solution or a feature running on the plurality of networked devices in response to the detected newly connected device or user thereof.
